(19) United States
(12) Patent Application Publication
(10) Pub. No.: US 2014/0337041 A1
(43) Pub. Date: Nov. 13, 2014

(54) Mobile Application for Defining, Sharing and Rewarding Compliance with a Blood Glucose Level Monitoring Regimen

(71) Applicants: Joseph Madden, Livermore, CA (US); James Garcia, Sunol, CA (US)

(72) Inventors: Joseph Madden, Livermore, CA (US); James Garcia, Sunol, CA (US)

(21) Appl. No.: 13/853,882

(22) Filed: Mar. 29, 2013

Related U.S. Application Data
(60) Provisional application No. 61/618,288, filed on Mar. 30, 2012.

(51) Int. Cl. G06F 19/00

(52) U.S. Cl. CPC G06F 19/3418
USPC 705/2

(57) ABSTRACT

The invention provides a mobile application, system, interface and method for monitoring, encouraging and rewarding user compliance with a blood glucose level monitoring regimen. It combines a server-client based application enabling scheduling of tasks, input of data, reminders, notifications, permission based sharing of data, synchronous messaging, rewards based on compliance, and community support cross-language and cross-platform. The client application is a mobile web application (such as an iphone application) installed on a network connected mobile or desktop device. The client application may also be a web site that is stored on a server and accessed through a network such as the internet. The server and mobile applications exchange data with one another through the network using standard networking and wireless protocols. The application defines and exchanges information according to permission based rules which can be monitored and modified remotely by a parent or guardian.

### CROSS-REFERENCE TO RELATED APPLICATIONS

This application claims the benefit of provisional application 61/618,288 filed Mar. 30, 2012 by the present inventors.

### BACKGROUND

1. Field of Invention

The present invention is a system, interface and method utilizing mobile application technology to define, verify, encourage and reward compliance with a task based health care maintenance regimen such as a blood glucose level monitoring regimen. It utilizes one or more servers, mobile web applications, and mobile devices allowing users to set goals, accomplish tasks, reward success and communicate with one another over a network such as the internet.

2. Background of Invention

Although the present invention can be applied to a variety of different behavior modifying applications, it will be described herein and defined from prior art in its special application to the management of blood glucose levels in diabetics.

Diabetes has emerged as a serious global health issue and in recent years has reached epidemic significance. In the year 2000, more than 151 million people in the world were diabetic. By 2010, nearly 220 million persons were diabetic and it is predicted that by 2025 the number of diabetic persons worldwide will reach 324 million. A large percentage of the worldwide population of diabetics lives in the United States.

The importance and frequency of measuring a diabetic's blood glucose level depends in part on the diabetic's diagnosis. There are two major forms of diabetes; type 1 and type 2. Type 1 diabetes is manifested with absolute insulin deficiency. In contrast, type 2 diabetes is characterized by both insulin deficiency and insulin resistance. As type 2 diabetes accounts for approximately 90% of the incidence of diabetes, the current epidemic increase in diabetes reflects a high prevalence of type 2 diabetes.

Type 1 diabetics usually must measure their blood glucose levels in the blood several times a day at regular intervals and particularly at meals. For type 2 diabetics, it is at least strongly recommended they check their blood glucose levels at longer regular intervals. Successful compliance with a regular blood glucose measurement regimen is a very important concern for many millions of people worldwide.

Failure to test blood glucose levels accurately and on a regular basis can result in serious diabetes-related complications, including cardiovascular disease, kidney disease, nerve damage and blindness. Thus, it is of upmost importance that the blood glucose levels of diabetic be measured regularly and accurately. Compliance with a blood glucose level regimen can be difficult and problematic particularly in the case of children who lack the knowledge, skill and maturity needed to successfully measure, enter and share blood glucose levels with adults and physicians. Parents and physicians helping treat and manage a diabetic child's compliance require detailed information about the diabetic's blood glucose levels, the time when those levels were recorded, the activities that took place at or around the time when the diabetic's blood glucose level was checked and the device with which the blood glucose levels were checked and/or recorded.

### GENERAL DISCUSSION OF PRIOR ART

There are numerous prior art methods for monitoring an individual diabetic's compliance with a blood glucose level maintenance regimen. One way is for the individual to simply remember facts and data. Another way is to keep a paper logbook. Another way is to log into a computer and enter information into a local database or through a network to a remote database. Yet another way is to use a monitoring device, such as a meter or other device having an entry system and database to record the information. Many diabetics utilize one or more of these prior art methods in managing their disease. However, such prior art methods are revealed as woefully inadequate because they fail to meet the particular needs of diabetics and their support group (parents, physicians and friends).

For example, prior art methods are generally inadequate considering the particular needs of children diabetics, their parents, physicians and support group. Child diabetics need a great deal of support and encouragement to make sure they check their blood glucose levels regularly and at the appropriate times. They need assistance in making sure the blood glucose levels are adequately recorded and communicated to physicians and other care givers. They often require prompting or reminding. And support persons need verification and assurance that a child is checking blood glucose levels at appropriately scheduled times. Sometimes, particularly with regard to nighttime blood glucose level maintenance, one or more parents or guardians are tasked with checking the blood glucose level of a child while he/she sleeps and at particular times. These support persons need to be prompted to make the necessary checks. Many times, the one or more support persons tasked with prompting and insuring blood glucose level maintenance of a child need verification from one another that the childs' blood glucose level has been appropriately checked and the data recorded. In other words, parents (as much as the diabetic child) have specific needs that must be met to assure coordination and compliance with a child's regimen. They must have the ability to coordinate care and be notified if a particular compliance event has been missed. A parent also needs to be able to monitor a child's compliance with the regimen independently of the child.

A parent or guardians needs are particularly acute if they are looking after a problem child living with diabetes. Most children have difficulty sticking to schedules and, as they grow older, will become resentful of defiant of persons who are constantly reminding them to comply with their maintenance regimen. Parent/child relationships are tested at best by the very constant and continuous requirements for compliance with a blood glucose level maintenance regimen that usually requires uncomfortable tasks such as the pricking of fingers. Many such relationships suffer significantly because the necessary nagging (and guilt associated with it) overrides other nurturing aspects of the relationship. Thus it becomes important for parents to find ways to motivate their children to comply in ways that do not require constant nagging and which help the diabetic child feel better herself and about her ability to manage her disease.

The family, friends and support persons of elderly diabetics have similar needs. They need reassurance that their loved one is checking her blood glucose levels and recording those levels accurately and in a timely fashion. Elderly persons often forget to check their blood glucose level or think they have done so when, in fact, they have not. Caring persons know this and are on often forced into a constant vigil to confirm that the regiment is met. But such elderly diabetics want to feel independent and able to take care of themselves, so they hide the fact that they may not be complying or can't remember whether they, in fact, have complied.

Children and some elderly persons may have difficulty understanding and operating sophisticated technological methods/devices for recording and sharing blood glucose information. Whatever system they use must be relatively easy to understand and operate. Even persons without significant impediments need to be reminded and motivated to check and record their blood glucose levels on a regular basis. They may not have time to fuss over a time consuming or difficult to operate methods for imputing or sharing data about their management compliance.

Feeling in control and motivated to comply with a maintenance regimen is a significant need among all diabetics. Sharing information with other diabetics or with support persons is an important way to maintain a sense of control and motivation and well-being. Support persons need to be able to communicate their care and trust in the diabetic. Diabetics need to hear positive reinforcement from their support community. And the right reinforcement at the right time (particularly when the diabetic has completed a task associated with management) is most beneficial to insuring continued compliance.

Most people (regardless of age) benefit greatly from goal setting and reward systems which provide positive reinforcement for healthy behavior. Current research provides supporting evidence that many diabetics, while they may be well aware of their specific needs and of the debilitating consequences associated with continued failure to adequately check blood glucose levels, will fail adequately comply with their blood glucose level maintenance regimen simply because they lack motivation. A diabetic who is regularly checking blood glucose levels and feels positive and secure about their blood glucose management is more likely to experience significant improvement in their overall health.

### SUMMARY OF SOME LIMITATIONS ASSOCIATED WITH PRIOR ART

Current prior art systems and methods have significant limiting factors in light of the particular needs discussed above.

Prior Art Limits on Sharing and Legal Compliance:

One limiting factor of the prior methods is that they do not allow individual users to easily share their data with other support persons. For example, in the case of diabetics who record blood glucose level information on mobile communication devices (such as smart phones), they must record the data and separately share the information through separate email applications, text applications or by phone. If they are uploading information to a website, they have to give support persons access to a website account and require those support persons to access the database separately in order to obtain the information. Such methods are cumbersome and unreliable.

Another limiting factor relating to sharing is that prior art systems do not provide for support persons to receive notifications (i.e. alerts) when the user has not complied with the predetermined management regimen. The support person can log in to a website to see whether the user has entered data, or the user can send an email or text message separately to the support person telling them that they have complied. But the system and methods do not account for easy communication with support persons. A parent, for example, might have to track down his son or daughter by phone or email to prompt compliance or ask whether he/she has checked and recording blood glucose level information.

A limiting factor associated with current prior art web and smart phone based systems is that the applications do not comply with COPPA legal requirements which restrict use by a minor under the age of 13 and require verified authorization by parents. Most systems exclude users under the age of 13 for this reason. In fact, many applications exclude and/or are not designed for users under the age of 18. The problem with this is that many diabetics are under the age of 18 and children who need significant assistance in managing blood glucose maintenance regimens are under the age of 13. The prior art applications, systems and methods aren't designed to appeal to and incentivize children to check and share blood glucose level information with parents and other support persons.

Another limiting factor regarding sharing is that prior art applications, system and methods do not account for the numerous platforms upon which the various users and support persons might be using. For example, many smart phone applications are limited to sharing on only one platform or language and persons who do not have a particular smart phone or receiving technology will not be able to upload or receive information from others who are utilizing a device running a different platform or language.

Prior Art Limitations Regarding Recording

Most prior art applications, systems and methods rely on manual recording of health care factors from the user. A standard prior art method for recording blood glucose information, for example, is with pen and paper or through use of a blood meter device. Other methods include the use of standard notation software or chat software loaded on mobile devices to record and share information. Use of recordation methods to record and share blood glucose data is cumbersome and time consuming.

Another limitation is that most prior art systems and methods which actually collect information directly from a mobile device (such as a smartphone) can do so only on a very limited number of devices that share the same platform or language. For example, a glucose level application might be able to accept, download and record a user's blood glucose level from a specific blood glucose meter but that same application would be limited for use with a particular type of meter. And prior art systems are unable to collect information using a variety of methods such as from infrared, OCR, direct input, photographic recognition and other methods that would allow the system and method to record information directly from a variety of testing equipment using a variety of output modes.

Another limitation of the prior art is that the timing for checking and inputting information is not adequately accounted for in prior art systems. For example, a person might be tasked with checking his/her blood glucose level using a test strip and reader and inputting that information in a handheld device which uploads the information to a server which, in turn, time stamps receipt of the information. But such prior art systems do not account for a user who might have checked a blood glucose level at the specified time (for example, in the morning) but forgot to input that information into the system until after the specified time (for example, the afternoon). The prior art system would simply receive the information and time stamp it as it is received into the system (e.g. in this case time stamping it as having been checked in the afternoon). While the user may be able to make a notation about timing of the input, there is no easy way to do so. This can be very limiting for diabetics who need to be precise about when they check their blood glucose and need to share accurate information with support persons who are interested in having accurate information as to when the user actually checked the blood glucose level. It can also be very limiting for parents who may want to incentivize a child to check and immediately enter information accurately.

Prior Art Limitations Regarding Verification and Confirmation of Data

Prior art systems and methods are often very limited in their ability to verify the accuracy of the information input by the user. They either provide no ability to verify input data or are limited in their ability to communicate with a variety of devices. This is similar to the sharing limitation. A computer connectable website or smart phone application, for example, may have the ability to tap into a specific blood glucose meter to download and verify information that was manually input by a user. But prior art systems are not set up to obtain information from a variety of different types of meters (all having different methods of output, running on different platforms or using different languages) and/or to easily verify the manually input information. It is often the case that a diabetics will utilize a variety of meters throughout the house, at work or at school to assist in reading and recording the user's blood glucose level. But the prior art contains no known applications, systems or methods allowing diabetics to collect data from a variety of different blood glucose meters, verify manually input data, and easily share that verified information with support persons.

Prior Art Limitations Regarding Motivation and Rewarding Users

One of the largest limitations of prior art systems and methods is their inability to motivate and reward the user when they are successful in managing their regime. A prior art system might incorporate a point system whereby the user obtains points for meeting certain goals. But such systems are not dynamic and are not designed to be motivating or provide support to children or young adults managing a difficult disease such as diabetes. For example, prior art rewards systems do not provide social motivation by allowing users to share points or earn points for others. They do not reward teamwork by providing reward incentives to friends and support persons to check up on and communicate with a user when that user fails to meet his/her goals. It is assumed, almost universally, that there is enough altruistic motivation for parents and friends to maintain close contact with diabetics and to make sure the diabetic is doing what he/she is supposed to do to maintain their health. And that may be true to some extent. But providing incentives to share and communicate information is all the more likely to lead to consistent compliance, particularly when multiple diabetic users are rewarded for compliance as a group. The prior art systems and methods ignore group reward incentives and do not account for the need of many support persons to have personal incentives that are real and tangible.

Ease of use is very important to adequately incentivizing individuals and groups. Social networks have been established to help individuals share information with supportive individuals. But the achievement of goals or points awarded in such prior art systems is specific to the individual user. They are either in it by themselves or they are forced to create group incentives outside the system. In other words, there is no mechanism built into the system and/or easily applied method to create a team based reward dynamic that would allow individuals to bond together to achieve success in their management regimen by using a single application. No known prior art method allows individual users to easily work together with other users within the same application to earn rewards as a team.

Team bonding and support communication mechanisms are perhaps more important than point systems in incentivizing and rewarding compliance with a health maintenance regimen. Mechanisms for building communication into a particular application can have a profound effect on motivating an individual or group of users to comply with management regimens. For example, a system and method that allows a support person to receive notification of an individual's compliance and the ability to send a chat message back to the individual saying “good job” or providing other types of support has a significant effect on whether the individual user feels supported or knows that others are relying on him/her to successfully comply with the regimen. A child diabetic may not care about the points awarded for compliance, but that same child can care greatly about a message from a friend who has been notified (or has earned points) because the child complied with his regimen. It is the social pressure and rewards that create dynamic and powerful incentives. The importance of such “rewards through communication” cannot be overstating for parents trying to help a child manage his/her blood glucose levels. For diseases such as diabetes that require constant monitoring and continuous sharing of information, the ability for a parent to immediately provide encouraging words to motivate and encourage the child can go a long way toward ensuring the child continues to adequately monitor his/her blood glucose level.

Perhaps one of the biggest drawbacks of prior art reward systems is that they are focused on incentivizing achievement of a particular range of values rather than on consistency in management tasks. In reference to rewarding or incentivizing diabetics to better manage their blood glucose levels, for example, a prior art system would be primarily focused on rewarding the individual diabetic for achieving a particular blood glucose level (or range). With regard to rewarding compliance with a weight loss regimen, for example, a prior art system would be focused on rewarding an participant for losing a certain amount of weight. The better the blood glucose value or the more weight is lost the more the individual participants are rewarded. So, for many prior art incentive systems, the term “compliance” really means achievement of a particular value. But there are many problems associated with this kind of incentive system. For one, they often don't work very well. Participants get frustrated and quit when they are slow to achieve their goals. A participant might be performing well in doing all the things that would usually lead to achievement of the goal (checking blood glucose levels regularly, eating well or exercising regularly) but for a great number of reasons their bodies simply do not respond as desired. Secondly, these value based systems rely on an accurate assessment of the goal to be achieved. Lowering a blood glucose level or losing even more weight may not be considered a good thing. It is up to a doctor or other health care professional to help the individual determine what range is correct or achievable. Further, these systems cease to work once the goal is achieved because there is no incentive for maintaining the desired value. It is better, in terms of incentives and rewards, for the system to focus on rewarding the behaviors that will lead to long term health. What is needed is a system that rewards behaviors which are proven to lead to the desired result, not reward achievement of the desired result itself.

What is needed is a system and method that easily allows individuals and support persons to record, share, verify and reward compliance with a health management regimen utilizing a variety of mobile devices cross platform and cross language. More importantly, the system and method must better meet the specific needs of the variety of individuals who are diabetics and support persons. They must incentivize and reward behaviors which will ultimately lead to the desired results.

### SUMMARY AND ADVANTAGES OF THE INVENTION

The present invention is an interface, system and method for recording, saving, sharing and rewarding user compliance with a health maintenance regimen such as regular blood glucose level monitoring or other task based behavior regimen. The interface, method and system combines a server-client based application enabling scheduling of tasks, input of data, reminders, alerts, permission based sharing of data, synchronous messaging, rewards based on compliance, and community support cross-language and cross-platform. The server application is installed on a network connected server. The client application is a mobile web application installed on a network connected mobile or desktop device. The server and mobile applications exchange data with one another through the network using standard networking and wireless protocols. The method and system is COPPA compliant in that it defines and exchanges information according to permission based rules which can be monitored and modified remotely by a parent or guardian. The method and system is focused on incentivizing compliance with a behavior regimen and not on achieving a particular value.

One example of a preferred embodiment of the invention is the Gluco-Share™ mobile web application and system which is specifically designed to motivate and reward diabetics for checking, recording and sharing blood glucose level data with other users and support persons. It is tailored specifically to allow parents or guardians to remotely monitor and modify their child's compliance with a blood glucose level maintenance schedule and to comply with COPPA laws which provide strict standards as to how identifying information may be shared with a system and other individuals. The method and system is also specifically designed to allow communities of users and support persons to compete with one another through a rewards system linked to user compliance. The system and method allows diabetics (whether children, teens or adults) to establish specific goals associated with behaviors that will lead to healthy results—they are rewarded for checking blood glucose levels at appropriate intervals, recording blood glucose level information, and sharing that information with support persons. They are able to receive instantaneous feedback from other users and support persons. The system and method takes advantage of social media type technology to reward and motivate users and their support community to achieve management goals in a team oriented setting.

Again, the invention is a system and method that easily allows individuals and support persons to record, share, verify and reward compliance with a behavior management regimen utilizing a variety of mobile devices cross platform and cross language. One preferred embodiment of that interface, method and system is Gluco-Share which assists users in tasks associated with managing a diabetic's blood glucose levels. The components and services provided by Gluco-Share are described in the Gluco-Share user's manual which is incorporated herein by reference in its entirety.

Some specific advantages of the present inventive interface, system and method over the prior art may be summarized as follows:
1) The present invention enables users to easily record information manually and through connection with a variety of devices.
2) The present invention provides for sharing with chosen support persons who might be using a variety of different types of mobile devices or computer based technology.
3) The present invention provides for smart alerts (notifications) for support persons who may want to be alerted when an individual has complied and/or when they have not complied.
4) The present invention is compliant with laws and regulations outlined in COPPA.
5) The present invention allows for easy verification of input data using a variety of different verification devices.
6) The present invention provides for individual and group rewards.
7) The present invention enables immediate synchronous and asynchronous in application communication between users and support persons.
8) The present system focuses on rewarding compliance with a behavior regimen that will most likely lead to the desired results.

Further details, objects and advantages of the present invention will become apparent through the following descriptions and will be included and incorporated herein.

### BRIEF DESCRIPTION OF THE DRAWINGS

FIG. 1 is an embodiment of a representative systems overview of the present invention showing one or more client devices communicating with a server over a network.

FIG. 2 is an embodiment of a high-level architecture of the present invention, showing client-side and server-side applications communicating over a network.

FIG. 3 is an embodiment of a high-level architecture map of the present invention showing the interface modules of the client-side application.

FIG. 4 is a platform map of the present invention showing integration of the application with mobile, web and third party services and devices.

FIGS. 5 (A through L) are embodiments of the user interface display pages associated with the mobile application's registration (and subscriber management) functionality.

FIGS. 6(A and B) are embodiments of user interface display pages associated with the client-side application's home screen and menu functionality.

FIGS. 7 (A through J) are embodiments of user interface display pages associated with the client-side application's Rewards functionality.

FIGS. 8 (A through D) are embodiments of user interface display pages associated with the client-side application's Check (Blood Glucose Level) functionality (i.e. the data input).

FIGS. 9 (A through M) are embodiments of user interface display pages associated with the client-side application's support network (Share) functionality.

FIGS. 10 (A through J) are embodiments of user interface display pages associated with the client-side application's Notifications functionality.

FIGS. 11 (A through K) are embodiments of user interface display pages associated with the client-side application's Permissions and Parental Controls functionality.

FIGS. 12 (A through B) are embodiments of user interface display pages associated with the client-side application's Setting functionality.

FIG. 13 is a flowchart showing an embodiment of the method for polling.

FIG. 14 is a flowchart showing an embodiment of a method for sending check notifications.

FIG. 15 is a flowchart showing an embodiment of a method for sending reminder notifications.

### DETAILED DESCRIPTION

The description that follows is presented to enable one skilled in the art to make and use the present invention, and is provided in the context of a particular application and its requirements. Various modifications to the disclosed embodiments will be apparent to those skilled in the art, and the general principles discussed below may be applied to the other embodiments and applications without departing from the scope and spirit of the invention. Therefore, the invention is not intended to be limited to the embodiments disclosed, but the invention is to be given the largest possible scope which is consistent with the principles and features described herein.

It will be understood that in the event parts of different embodiments have similar functions or uses, they may have been given similar or identical reference numerals or descriptions. It will be understood that such duplication of reference numerals is intended solely for efficiency and ease of understanding the present invention, and are not to be construed as limiting in any way, or as implying that the various embodiments themselves are identical.

Unless defined otherwise, all technical and scientific terms used herein have the same meaning as commonly understood by one of ordinary skill in the art to which the present invention belongs. However, some specific definitions are presented below.

The term “support persons” encompasses all individuals who are supporting a registered user whether or not that support person is another diabetic, parent, health care provider or other person. In most cases, the term “support person” refers to another registered user who also has access to the system and application.

The term “administrator” refers to an individual who is responsible for administering the system of the present invention, performing duties such as account and database management.

The terms “user” refers to the individual who is executing the management plan; this individual interacts with the system primarily via the mobile client-side application. Users can also be defined as registered users, patients, parents, caregivers and other support persons.

The term “users” or “registered users” refers collectively to those individuals who have access to the system of the present invention, including physicians, administrators and end users. The term “non-user” refers to any individual who does not have access to either the server-side and/or client-side applications described herein, yet may be recipient of the content generated by the same.

The term “management regimen” or “regimen” refers to the defined series of scheduled events each occurring at a specific time (and in some cases place) and consisting of one or more actionable activities sometimes referred to herein as “tasks”. For example, a management regimen for the Gluco-Share embodiment would include the scheduled taking, inputting and sharing of blood glucose level data and related information.

The term “video display” refers to devices upon which information may be displayed in a manner perceptible to a user, such as, for example, a computer monitor, cathode ray tube, liquid crystal display, light emitting diode display, touchpad or touchscreen display, and/or other means known in the art for emitting a visually perceptible output. Video displays may be electronically connected to a client device according to hardware and software known in the art.

In an implementation of a preferred embodiment of the invention, a “display page” may include a computer file residing in memory which may be transmitted from a server over a network to a mobile device which can store it in memory. A mobile device may receive non-transitionary computer readable media, which may contain instructions, logic, data or code that may be stored in persistent or temporary memory of the mobile device. Similarly, one or more servers may communicate with one or more client devices across a network, and may transmit computer files residing in memory. The network, for example, can include the Internet, wireless communication network, or any other network for connecting one or more client devices to one or more servers.

Any discussion of “client-side application” may also apply to a mobile application which is downloaded to or stored on a client device and/or mobile device.

Any discussion of “client”, “client device” or “mobile device” may also apply to any type of networked device, including but not limited to phones such as cellular phones (e.g. an iPhone, Android, Windows Mobile, Blackberry, or any “smart phone”) or location-aware portable phones (such as GPS); embedded or specialty device; or viewing device (such as AppleTV, Google TV, Roku, Smart TV, Picture Frame or other viewing device); personal computer, server computer, or laptop computer; personal digital assistants (PDAs) such as Palm-based devices or tablet devices (such as iPad, Kindle Fire, or any tablet device); a roaming device such as a network-connected roaming device or other device capable of communicating wirelessly with a computer network; or any other type of network device that may communicate over a network and handle electronic transactions. Any discussion of any device mentioned may also apply to other devices.

At a client device, the “display page” or “user interface” may be interpreted by software residing on a memory of the client device, causing the computer file to be displayed on a video display in a manner perceivable by a user. The display pages (i.e. screens) described herein may be created using a software language known in the art such as, for example, the hypertext mark-up language (“HTML”), the dynamic hypertext mark-up language (“DHTML”), HTML5, the extensible hypertext mark-up language (“XHTML”), the extensible mark-up language (“XML”), or another software language that may be used to create a computer file displayable on a video display in a manner perceivable by a user. Any computer readable media with logic, code, data, instructions, may be used to implement any software or steps or methodology. Where a network comprises the Internet, a display page may comprise a webpage of a type known in the art.

The terms “page” or “display page” may include embedded functions comprising software programs stored on a memory, such as, for example, Cocoa, VBScript routines, Jscript routines, JavaScript routines, Java applets, ActiveX components, ASP.NET, AJAX, Flash applets, Silverlight applets, Adobe AIR routines, or any other scripting language.

A display page may comprise well known features of graphical user interface technology, such as, for example, frames, windows, tabs, scroll bars, buttons, icons, menus, fields, and hyperlinks, and well known features such as a touchscreen interface. Pointing to and touching on a graphical interface button, icon, menu option, or hyperlink also is known as “selecting” the button, icon, option, or hyperlink. Additionally, a “point and gesture” interface may be utilized, such as a hand-gesture driven interface. Any other interface for interacting with a graphical user interface may be utilized. A display page according to the invention also may incorporate multimedia features. For example, a user interface may be provided for a web page or for an application. An application may be accessed remotely or locally. A user interface may be provide for a mobile application (e.g. iPhone application), gadget, widget, tool, plug-in, or any other type of object, application or software.

Any of the client or server devices described may have tangible computer readable media with logic, code, or instructions for performing any actions described herein or running any algorithm. The devices with such computer readable media may be specially programmed to perform the actions dictated by the computer readable media. In some embodiments, the devices may be specially programmed to perform one or more tasks relating to blood glucose management. In some embodiments, the devices may communicate with or receive data collected from one or more measurement or sensing devices, which may collect physiological data from a subject or from a sample collected from a subject.

The term “time” refers to a chronological time or timeframe, including but not limited to morning, afternoon, evening, breakfast, lunch, dinner, night time, beginning, end, etc.

Other examples of protocols or standard communications means between the server and the client included within the scope of this invention include but are not limited to standard telephone lines, LAN or WAN links (e.g., T1, T3, 56 kb, X.25), broadband connections (ISDN, Frame Relay, ATM), and wireless connections using a variety of communication protocols (e.g. HTTP, HTTPS, XML, JSON, TCP/IP, IPX, SPX, NetBIOS, Ethernet, RS232, messaging application programming interface (MAPI) protocol, real-time streaming protocol (RTSP), real-time streaming protocol used for user datagram protocol scheme (RTSPU), the Progressive Networks Multimedia (PDN) protocol, manufacturing message specification (MMS) protocol, wireless application protocol (WAP) and direct asynchronous connections.

Various embodiments of the architecture are now presented in greater detail.

### Overview of the System

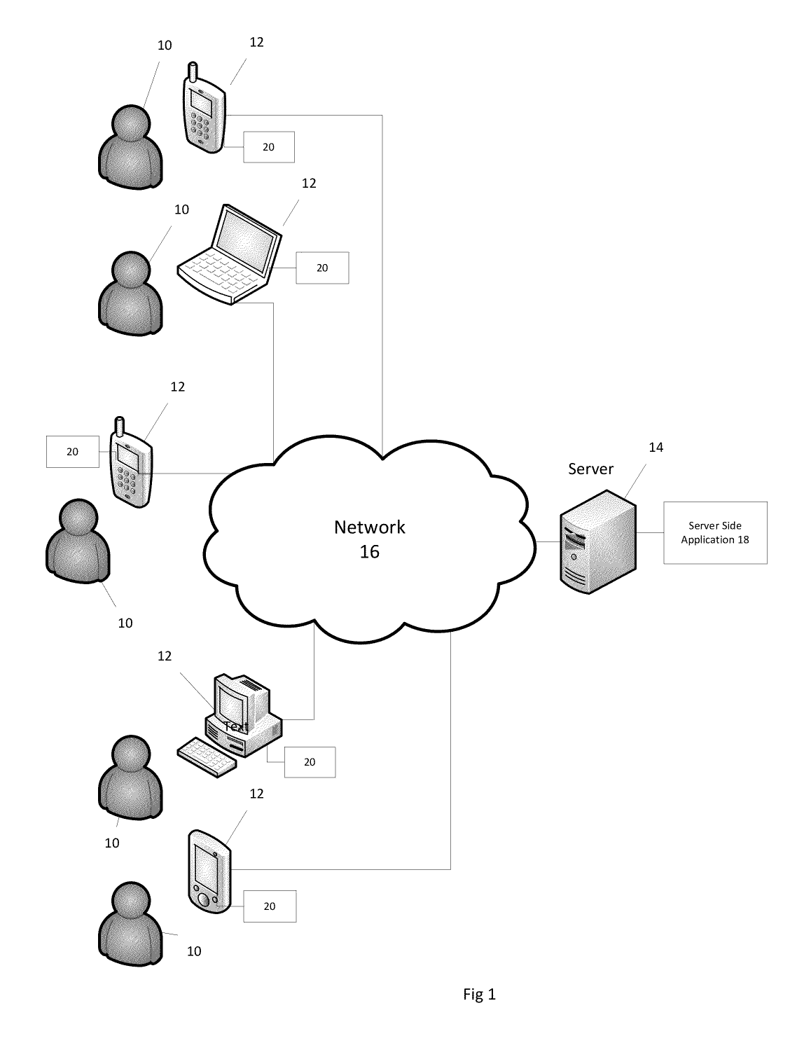

FIG. 1 is an embodiment of a representative systems overview of the present invention showing one or more users 10 utilizing one or more mobile devices 12 to communicate with a server 14 over a network 16. Using this system, a server-based application 18 residing on the server 14 may communicate with the client-side application 20 via network 16 and mobile device 12. The client-side application 20 is downloaded onto a mobile device 12 by a user 10. The client-side application 20 may be in communication with one or more additional client-side applications 20 depending on rules, permissions and connections held by and established through the business logic of the server-side application 18.

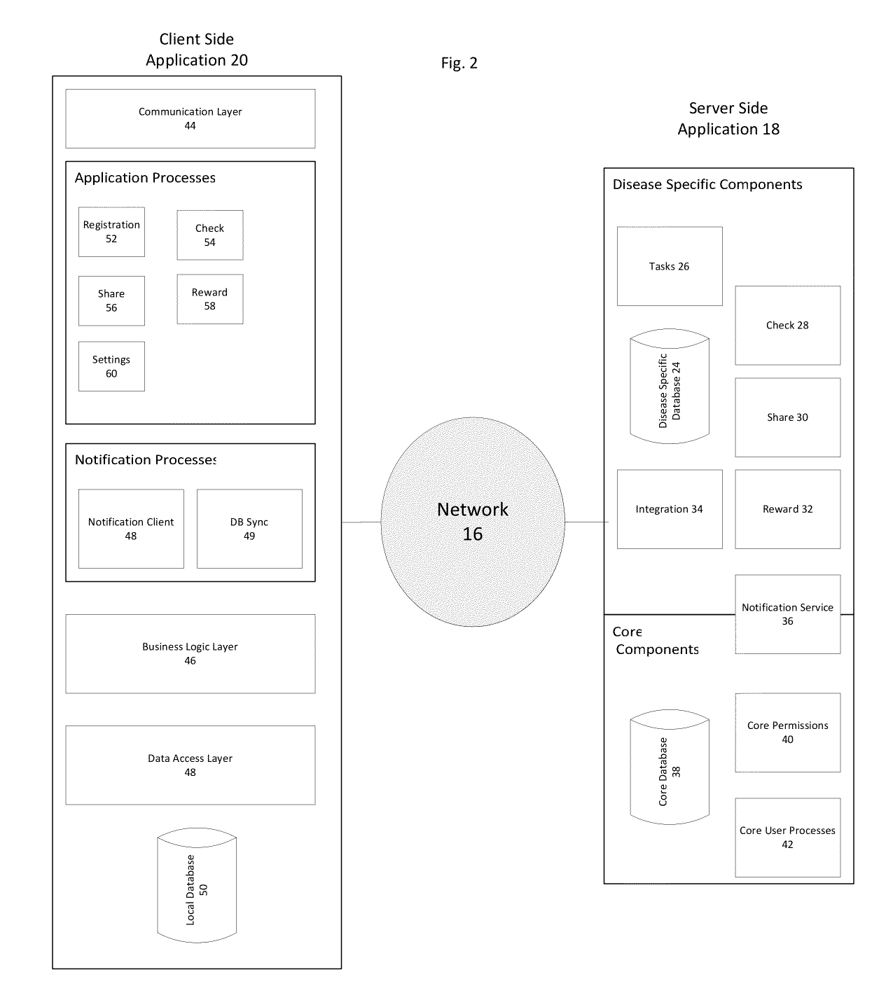

FIG. 2 is an embodiment of a high-level architecture of present invention, showing client-side 20 and server-side 18 applications communicating over a network 16. In a preferred embodiment for assisting users in managing their blood glucose levels, the system enables a user to schedule times in which blood glucose levels are to be checked and data regarding those levels inputted into a database by accessing an application stored locally on a mobile device and storing information both locally and on a server-side database via the internet, with responsibility for the management of user accounts and databases assumed by an administrator.

### Server-Side Architecture

The right side of FIG. 2 shows the high-level architecture of the server-side application 18. The logical modules, databases and user interface components of the software application that is installed on a network connected server are shown. In a preferred embodiment, there are two or more groupings of system components, databases, process modules and user interfaces. Those specific to the management of a particular disease (for example, those relating specifically to a application designed to assist users in checking, sharing and rewarding compliance with a blood glucose level management regimen such as the Gluco-share application) are shown as Disease Specific Components. The more generic system components, databases, process modules and administrative interfaces which are part of the core system and not linked to a specific disease are shown as Core Components. The Notifications (Scheduling) processes are shared between the Disease Specific Components and the Core Components.

The system may be utilized to manage more than one type of disease. And, therefore, there may be more than one set of Disease Specific Components which will communicate with the same set of Core Components. In other words, the system is expandable to incorporate other mobile applications written specifically to manage a particular disease. Each mobile application will have its own set of system components, databases, process modules and interfaces designed specifically to assist in the management of a particular disease. However, the core system, databases, processes, and interfaces are used in conjunction with each disease specific application. An example of a disease specific mobile application is the Gluco-Share mobile application which is designed specifically for use in managing diabetes.

Within each In the Disease Specific application, there are one or more disease specific databases 24 for storing information particular to the management of a particular disease. The one or more disease specific databases 24 for the Gluco-share embodiment would, for example, store disease specific information such as glucose level, insulin used, diabetes type, and other such information relevant to the management of diabetes.

The Disease Specific Components include processes (and accompanying interfaces) which would be specific to the management of a particular disease. For example, the Gluco-Share application includes processes and interfaces for defining, recording and rewarding compliance with specific tasks such as recording glucose readings, recording readings date and time, recording insulin delivered, recording diabetes type, and similar tasks relevant to the management of a diabetic's blood glucose level.

The main disease specific processes associated with the Gluco-Share application include:
Tasks processes 26 defining the specific tasks that a user must complete in order to comply with a blood glucose management regimen. Such tasks would include, but not be limited to, checking and sharing blood glucose levels.
   Check processes 28 associated with the storage and retrieval of specific blood glucose level readings that were input into the system by the user and/or a connected device.
   Share processes 30 associated with adding and removing friends, and setting privileges for friends.
   Reward processes 32 associated with generating and redeeming tokens for real prizes and medallions. The difference between real prizes and medallions is that real prizes are actual products or services whereas medallions are points/units that can be tallied and used to redeem rewards. The Reward process would also include processes associated with transferring medallions to friends.
   Integration processes associated with pulling in data from other sources such as meters or other reader devices uses to determine blood glucose level. The Integration processes also include pushing data such as stored blood glucose level information to personal user databases or third party websites.
   Notification (Scheduling) processes associated with providing notifications to others across the network including but not limited to native messaging (for example, an IOS push for iphone devices), SMS and email.

As provided above, Core Components consist of one or more databases and processes for generic systems maintenance, administrative management purposes and establishing global permissions for one or more disease specific health management mobile applications. The one or more Core databases 38 store generic user information such as name, address, email information and system passwords that are not specific to a particular disease or health condition. Core Permissions are permissions processes associated with permissions granted by the user across multiple health care maintenance application. Core User Processes 42 are generic (i.e system management) processes such processes for adding users, remove users, changing user passwords, session management control and management of global permissions. By separating generic administrative information from disease specific data and processes, the system allows a user to register within a global system and provide permissions and other non-disease specific processes which can be applied to more than one health care management application. Examples of alternative care (i.e. disease) specific applications would include applications designed specifically to help users managing body weight, blood pressure, diet, cancer, depression and other common health care management issues.

### Client-Side Architecture

Within the system of the present invention, the role of the user is to execute the scheduled maintenance regimen, to record data, to provide feedback to other users regarding compliance with personal goals as well as to ensure goals of others users are achieved. In the preferred embodiment, Gluco-Share, this is accomplished via a client-side application and databases, installed on an Internet-enabled mobile device. In an alternative embodiment, some or all of the functionality could be accomplished via a Web browser connected to a server-based application.

The left side of FIG. 2 depicts the high-level architecture of the client-side application. A schematic block diagram is presented showing an embodiment of the client-side application of the present invention. The various functional process modules of client-side application include 1) Check, 2) Share, 3) Reward and 4) Settings which are mirrored within the main menu of the client-side application. Although there are various functionalities defined within each module, each module description is provided as an overview of the navigational aspects of the application.

The client-side application may be a standalone application, or may be part of or otherwise associated with a larger application or software, such as medical data management software. In some implementations, the client-side application may communicate with larger data management software stored on one or more servers or share data or information with the larger data management software. Any discussion of a client-side application herein may apply to any iPhone application, any other “smart phone” application, mobile device application, gadget, widget, tool, plug-in, or any other type of dynamic content, object, application, or software.

A client-side application may be a miniature object that may offer dynamic content that can be placed on any page of the web, phone, or computer desktop environment. The client-side application may be utilized by a roaming device, such as a network-connected roaming device such as a phone, PDA, GPS, or any other mobile device. The client-side application may provide a smaller application (e.g. gadget, widget, tool, object, or program) that may not require the complexity, power, or memory of a full-sized server-side management application. The client-side application may enable a user to interact with other client-side applications as well as a larger software application hosted on a server or other complex centralized system.

In a preferable embodiment, the server-side application resides at the server and the client-side application is a mobile application residing in local memory on a mobile device (such as an iPhone, Blackberry, or other “smart phone”). In some instances, the mobile application may have been downloaded to the mobile client device from the server. The mobile application on the client device may communicate with server-side application on the server. In some instances, the client-side application may primarily function as a standalone application, but may communicate with the server-side application in particular situations. Any communications may occur between the server-side application and the client-side application over a network (such as the Internet), via wired connection or wirelessly.

The client-side application may share data with the server-side application or another application. For example, the client-side application and the server-side application may access the same data. In some instances, the data may be stored in one or more databases. The data may be stored locally with the server-side application, locally with the client-side application, or may be stored at another system or memory (e.g. a server or client device). The data may or may not be divided and stored on different memories.

Data may be stored on a plurality of databases. These databases may be stored anywhere. For example, they may be stored on the same system or on different systems. In one embodiment, the server-side application may be configured to have access to all or most of the data in the databases. The client-side application may access data in the same set of databases. In some instances, the client-side application may access less data than is accessed by the server-side application.

In any of these situations, the server-side application and the client-side application may be stored on the same system or on different systems. Similarly, the databases may be stored on the same system or different systems. In some embodiments, the databases may belong to a single organization or may be shared by multiple organizations. Any components that may be stored on different systems may communicate with one another over a network, including but not limited to a wireless communications network, the Internet, a local area network. In one example, a data management software program may be stored on a server and may be accessed by a client device, mobile device (such as a iPhone), or any other type of device. A mobile application may reside on an iPhone, “smart phone”, cellular phone, PDA, or any other type of device and the databases may be stored on one or more server.

Any form of interaction across one or more systems may be provided, including communication between various applications and/or sharing of data.

The client-side application may be created by any technique known in the art. In a preferred embodiment, the client-side application is created to be compatible with a particular device. For example, the client-side application may be an iPhone application configured to operate on an iPhone device. Thus, the client-side application may operate in an iPhone environment. In some implementations, the client-side application may be a gadget operable to run in an existing environment.

The data provided in the client-side application may be available via a web service to a dedicated secure socket for the client-side application for retrieval and refreshing of data. The connection may be HIPPA compliant. The connection may also be COPPA compliant. The client-side application may establish an SSL connection (or some other type of secure connection) which may require the user to enter an ID and password.

In some embodiments, the server-side application may be protected in the application server and made available to another web server hosted by a wireless communication provider (e.g. AT&T, Verizon etc.). Similarly, the client-side application may or may not be available directly to the public.

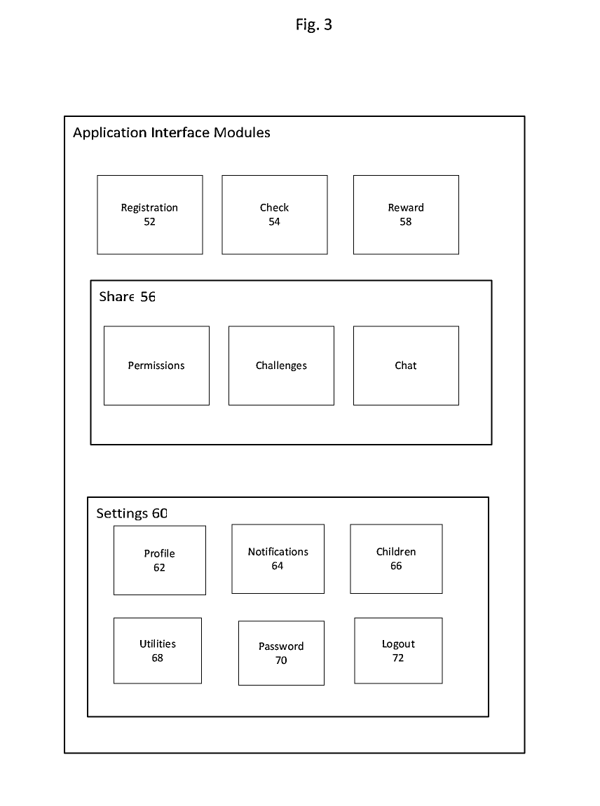

Referring specifically to the left side of FIG. 2, the Client-Side Architecture includes various processes and functions that operate locally to enable the mobile or web based application. The Communication Layer 44 controls all data coming from non-browser systems such as mobile devices, other application servers, or partner servers. It accepts data from an external source, authenticates the source, validates its authorization and passes the request to the appropriate part of the Business Logic Layer 46. The Web Application is the user front end to all browser based communications and is accessible by the user through the user interface (see FIG. 3). The Notification Client 48 is a background process that handles the pushing of messages to users. This includes IOS push notifications, SMS and Email. The DB Sync 49 is a background process that synchronize databases between geographic regions and database architectures. This application based server processor ensures fault tolerance and high availability. The Business Logic Layer 46 controls the processing of data. It manages who can see what data and translates the data to a form that the front end systems are expecting. The Data Access Layer 48 controls all encrypting and decrypting of sensitive data fields and controls all access to the database systems. The Local Database 50 is one or more local databases (i.e. located at the mobile device) which store information input by the user.

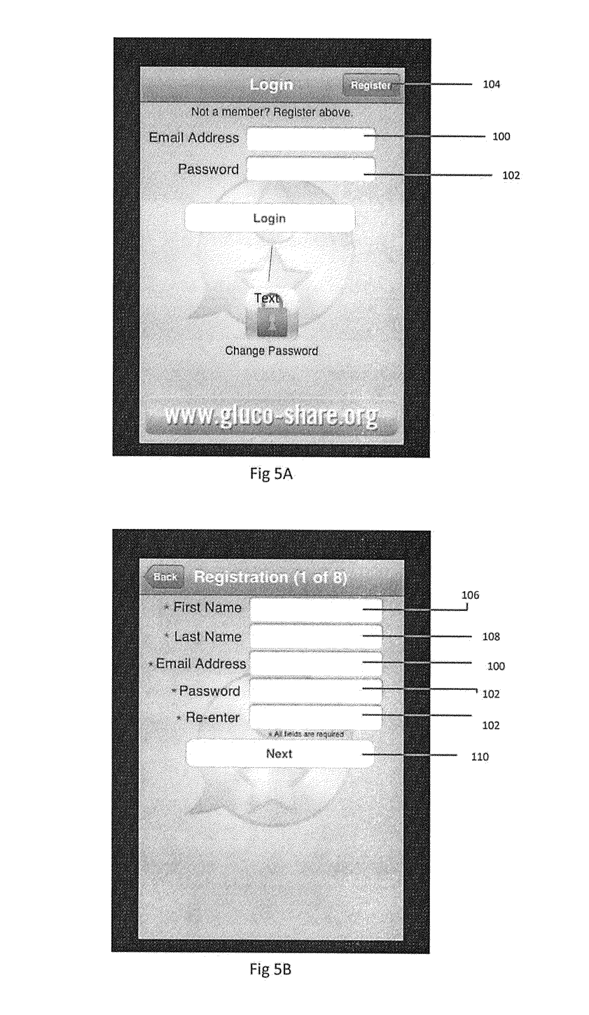

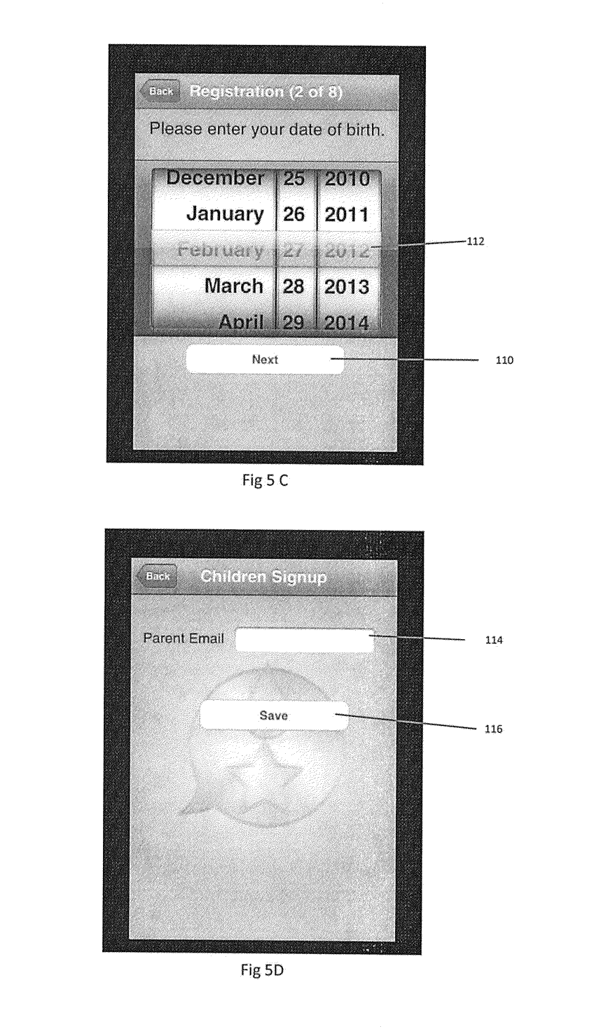

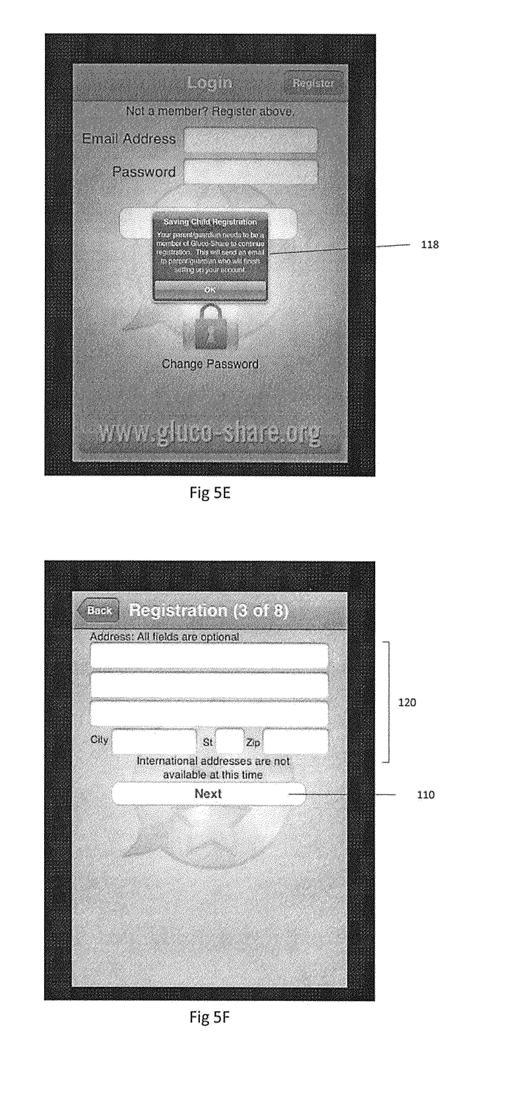

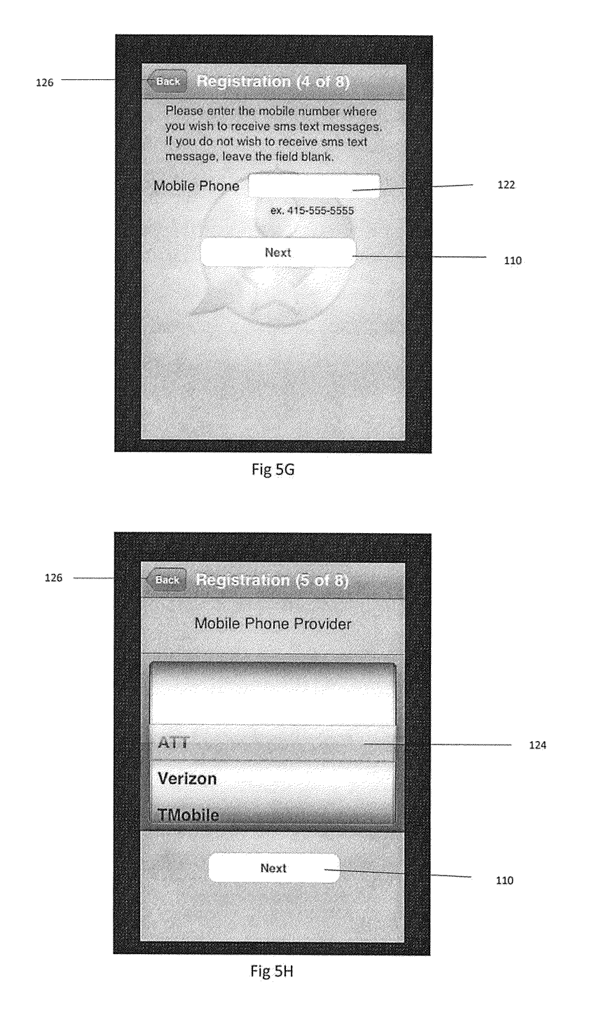

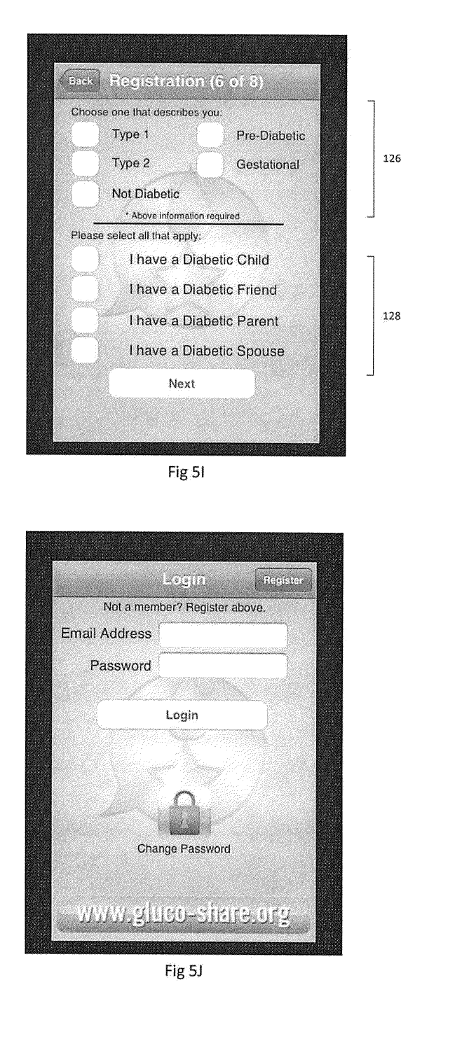

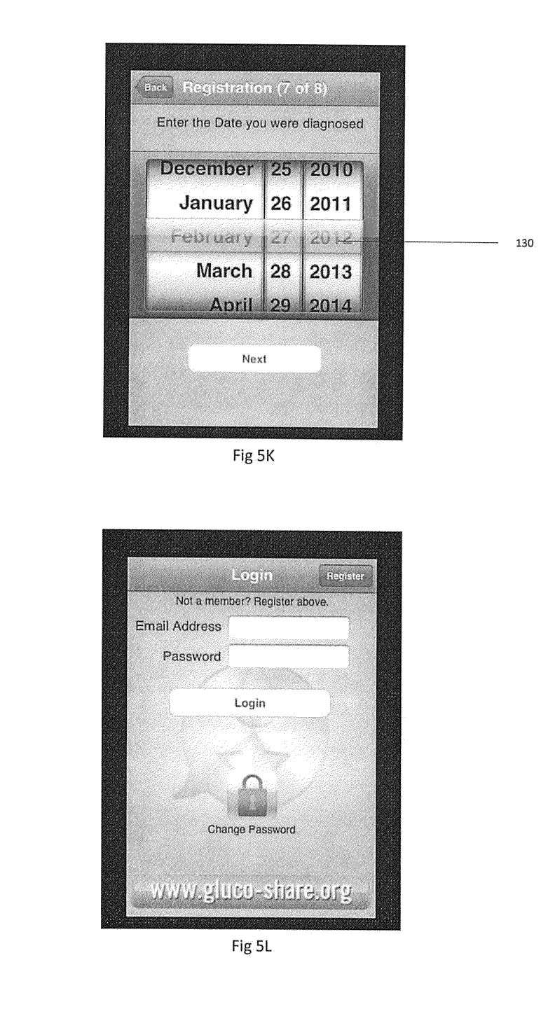

FIG. 3 is a block diagram showing the various user interface modules of the client side application. Those modules include Registration 52, Check 54, Share 56, Reward 58 and Settings 60. Within the Settings module are sub-modules pertaining to specific administrative functions including setting a Profile 62, Notifications 64, Children 66, Utilities 68, Password 70 and Logout 72 functions. Examples of functionality and associated display pages (or user interface pages) specific to each module and sub-module are shown and described more specifically in FIGS. 5-12 and the associated discussion below.

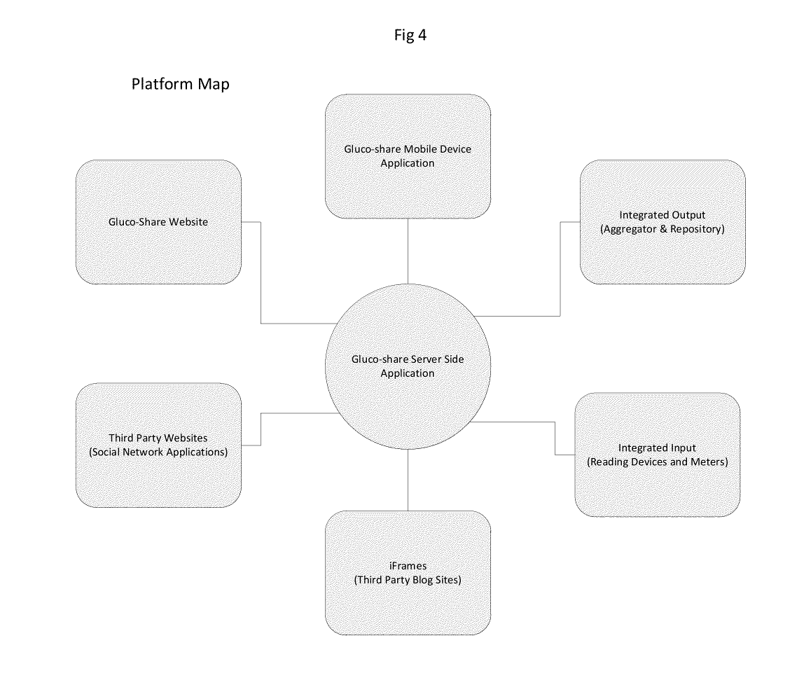

FIG. 4 is a platform map of the present invention showing integration of the server side application, the mobile device application, a web based application, third party social networking applications, integrated output devices and services (aggregator & repository), and integrated input devices and services (such as reading devices and meters). The illustration uses the Gluco-Share embodiment of the invention for illustrative purposes. Each individual client-side application communicates to the server side application. Each user communicates to each other by transmitting the data to the server via network and the server transmitting the data to the other users via network. Excluding the server application (i.e. web application), each client side application is either a mobile application or embedded application (such as an Apple TV embedded application). With regard to meters and other input devices, each communicates directly with the server application. With regard to iframe or third party blog sites, such client side applications are a skinned version of the web application made to look like the hosting parties website. The user logs into the hosting party's site and is linked to the specially skinned web application and communicates with the server via network. With regard to aggregators and repositories, the system receives information from many different sources such as glucose level reading meters, meter interface service (such as the Diasend and Glooko services), mobile application and other diabetes focused applications. The system aggregates this information into one common repository for access through the server. The purpose of the map is to show the integration of the system components to provide a comprehensive service to the user from various mobile and web sources.

### Registration Functionality and Interface

FIGS. 5(A through L) depict an embodiment of the user interface in greater detail. These are “display pages” of the Gluco-share embodiment showing the user interface associated with the client-side version of the application's Registration 52 process module (i.e. subscriber management) functionality.

A user may download to or store a client-side version of the application on a mobile device such as a smartphone. To initiate registration with system, a user will move from the home page to the registration page by selecting the “register” button on the bottom left of the login screen. At the registration page, the user may enter registration information (name, email etc.) and enter a password for future access to the system.

FIG. 5A shows an embodiment of a Login screen where the user is prompted to input an email address 100 and well as a password 102. If the user is not already registered, the user may press the “Register” button 104 which will take the user to the first of several registration pages such as that depicted by FIG. 5B where the user is prompted to enter contact information such as first name 106, last name 108, email address 100, and password 102. By pressing the “Next” button, the system will navigate to another registration page such as that depicted by FIG. 5C where the user is prompted to enter a birthdate.

Included within the registration module are special procedures for compliance with legal limitations involving the use of information of persons under the age of 13 (specifically, the COPPA requirements). Once the user's birth date 112 is entered (FIG. 5C), the user may select the “Next” button 110 at which time the user will either be presented with registration protocol pertaining to persons over the age of 13 or protocol pertaining to persons under the age of 13.

If the user enters a birth date that makes the user younger than 13 years of age, the system will navigate to a page such as that depicted by FIG. 5D where user will be asked to submit a parent email address 114. Once the parent's email address is entered and the user presses the “Save” button 116, the system will save the parent's email address and send an email message to the parent at the entered parent's email address asking the parent to set up (i.e. authorize and initiate) the registration of their child under age 13. If a child under 13 attempts to login to the system using name and password, but the parent has yet to complete the registration for the child, the system will provide a Notice 118 such as that depicted by FIG. 5E and the application will terminate. If the system matches the entered email address with a registered parent who has completed all permissions to allow the child to access the application, the child will be allowed to access the application.

If at login screen FIG. 5C, the registering user enters a birth date that make the user 13 years of age or older, the user will complete the registration process by entering mailing address information and pressing the “Next” button (See FIG. 5 F).

Note that the requested Registration information is not entered into the system until the requested information is provided and Next button is pressed, in which case the system navigates to the next display page in order. A user may navigate back to the previous page by pressing the “Back” button which is usually located on the upper left corner of the display page. FIGS. 5G and 5H provide an example.

The user may select a SMS text messaging option in which case the user would enter a mobile phone number 122 (See FIG. 5G) and carrier information 124 (See FIG. 5H) that would allow the application to send text messages to a mobile phone device.

Importantly, the registration module includes a display page (See FIG. 5I) at which the user may enter disease specific information, in this case pertaining to the type of diabetes 126 (such as type 1, type 2, pre-diabetic, gestational, not diabetic etc.) and provide other information that tells the system why the user is registering 128 (such as the user has a diabetic child or friend, parent or spouse).

FIG. 5J is a login screen.

The registration module may also provide additional display pages requesting other disease specific information. For example, FIG. 5K is an example of a display page where the user may enter the date when the user was diagnosed with diabetes 130.

FIG. 5L is a login screen.

The registration module allows the user to change a password using an email confirmation process. The user may enter an email address and password, press the “Change Password button, and the system will send an email to the user with emailed acceptance link. The user's password will not change until the user accepts the change using the emailed acceptance link. This provides a level of security to password changes and assures that the password change was confirmed by the person who has access to the registered email account.

### Menu Functionality and Interface

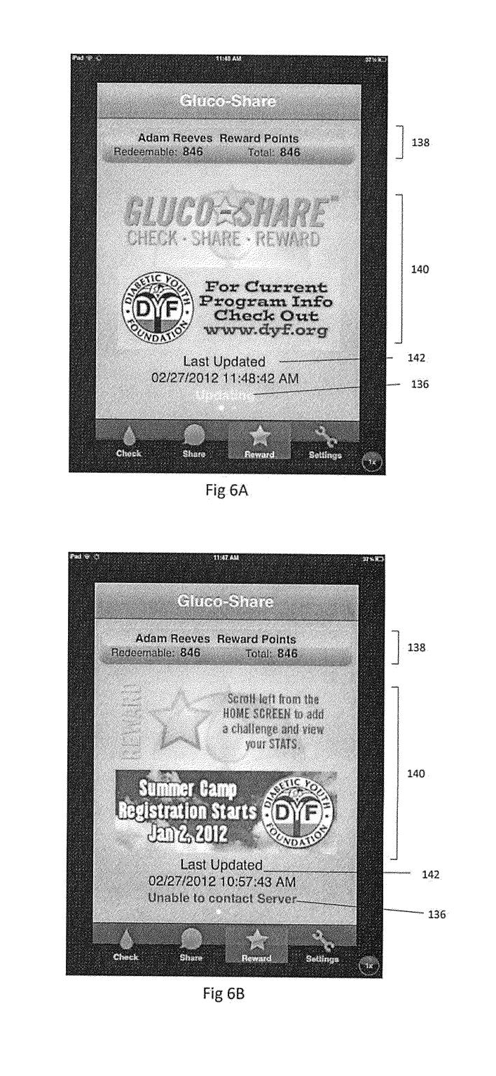

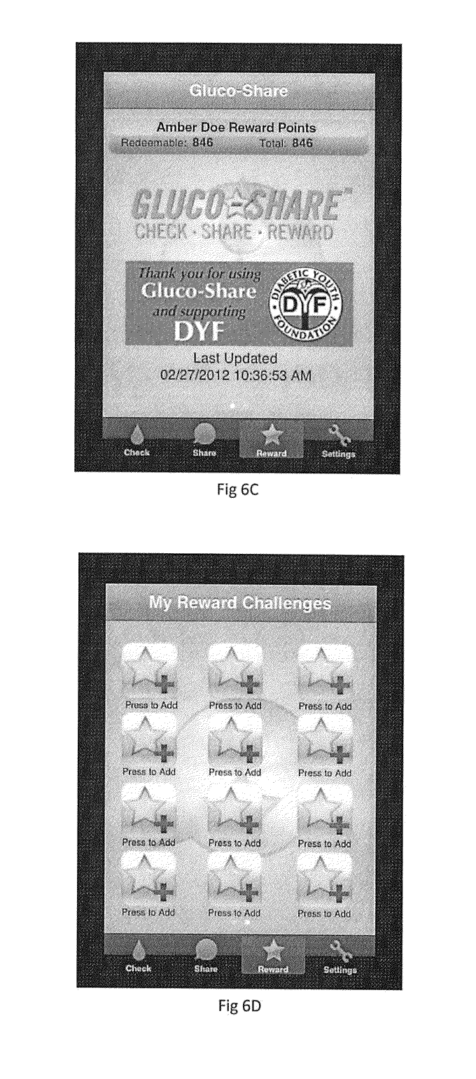

FIGS. 6(A and B) are examples of display pages depicting the user interface of the Gluco-share embodiment associated with the client-side application's home screen and menu functionality. Once the user has logged into the system, the system will navigate to a home page. FIGS. 6A and 6B are both examples of a home page. The system allows the user to access the application when it is connected to the server (online) and when it is not (offline).

If the application is able to connect to the server using the mobile device web connectivity, the user's application will immediately be updated and the home page will indicate that the application is updating (See FIG. 6A). If there is no connectivity at the time the user attempts to login to the application, the home page will indicate that the user is working offline (See FIG. 6B). Users who are accessing the client side application and system on a mobile device may or may not have connectivity to a wireless or other connection to a network connected to the system server (such as the Internet) at any given time.

It is not uncommon for any user of any mobile device (whether part of the present invention or not) to move in and out of connectivity with a network during use of the device. In the case of the present invention, the system is designed for use whether there is connectivity (i.e. the application is on-line) and when there is not connectively (i.e. the application is working off-line).

The home screen, in addition to providing information about connectivity 136, may provide a welcome screen having the name of the user, and other information pertinent to user's account (such as reward points 138). The home page may provide links or advertising offers 140. It may provide a date when the users account was last updated 142.

The current embodiment of the application provides a menu with four functional choices marked home, check, friends and settings with appropriate icons.

### Rewards Functionality and Interface

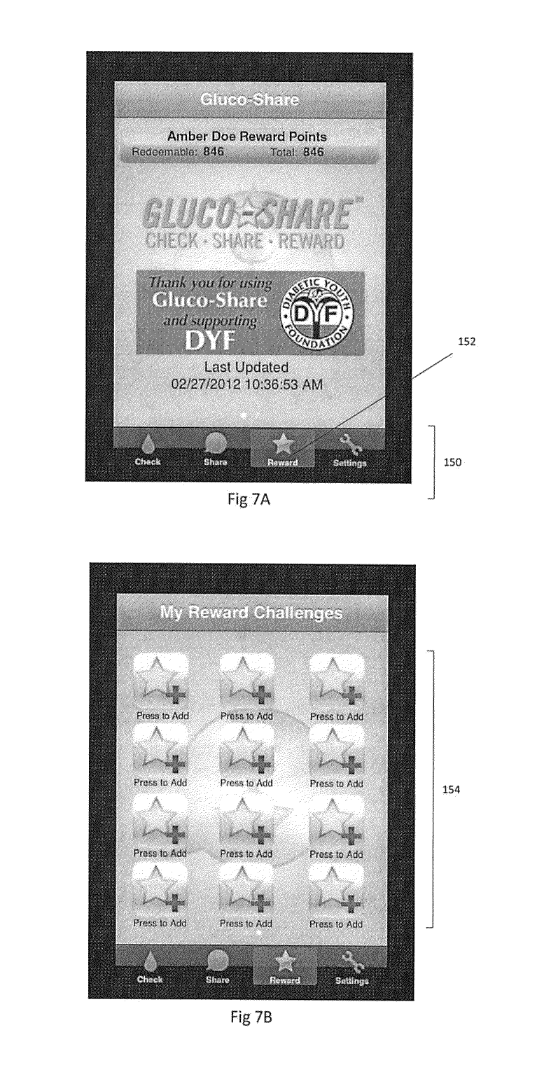

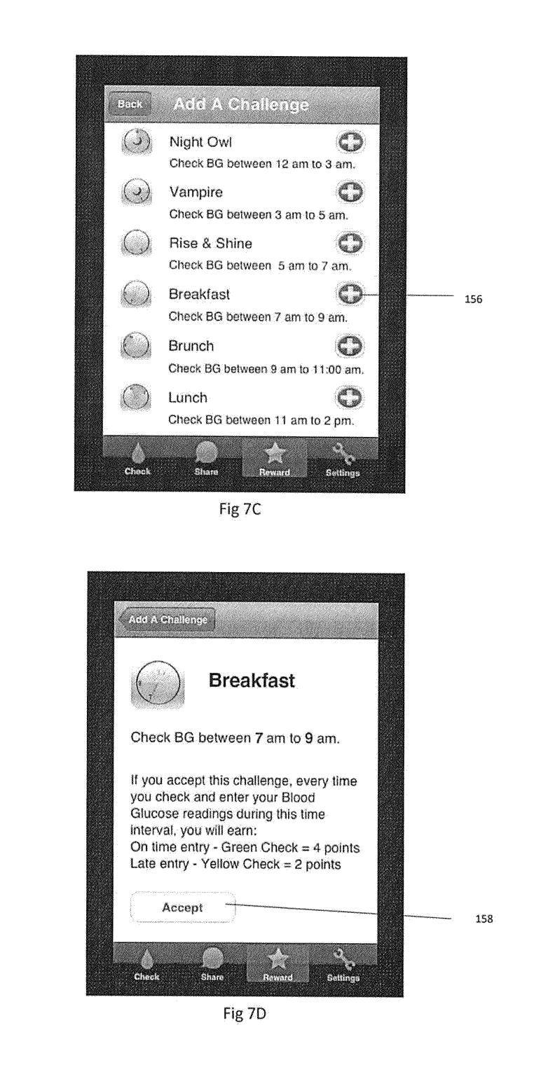

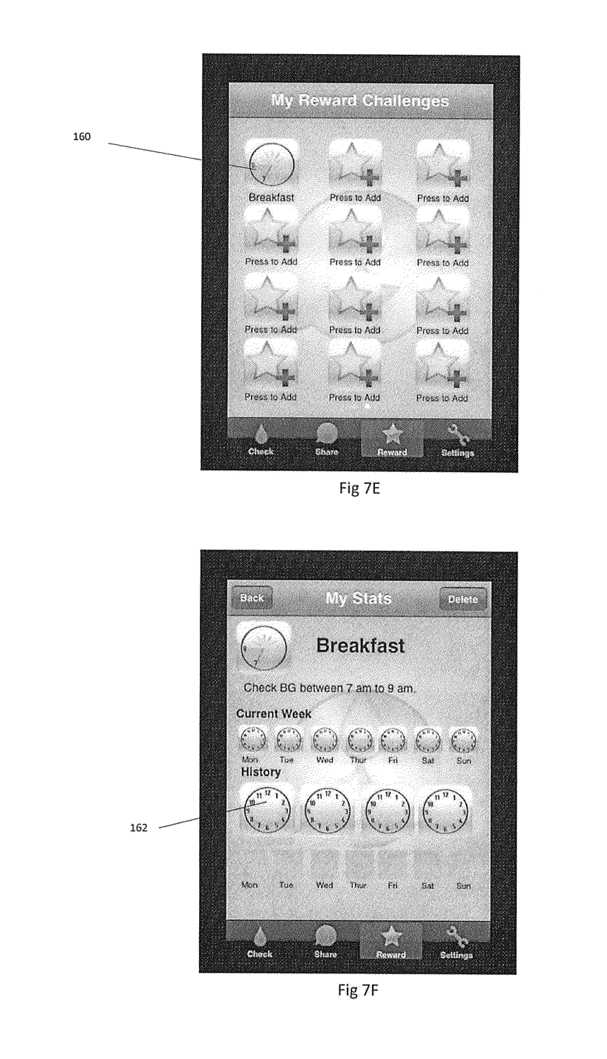

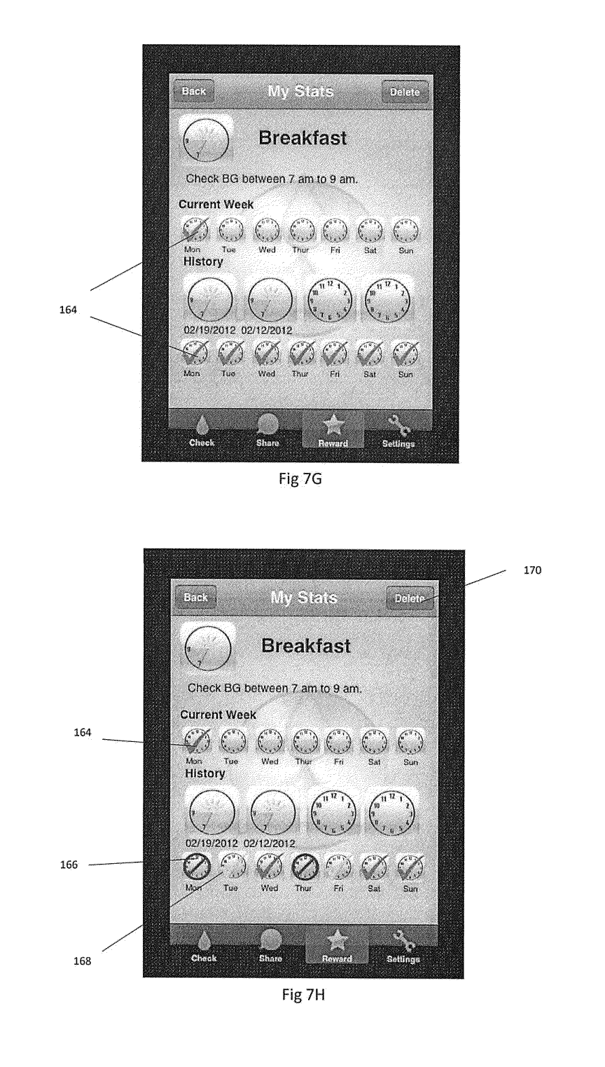

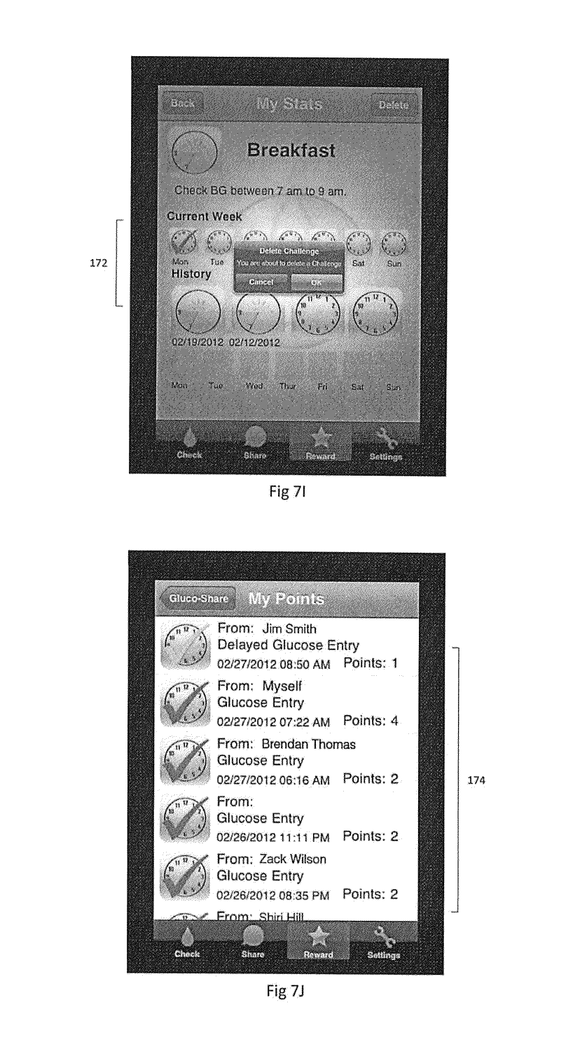

FIGS. 7(A through J) depict an embodiment of the user interface in greater detail. They are “display pages” of the Gluco-share embodiment depicting the user interface associated with the application's Rewards functionality (i.e. setting and meeting personal challenges).

FIG. 7A is a screen shot of an example home screen similar to that shown in FIGS. 6A and 6B. Each home screen has a menu 150 with one or more icons (i.e buttons) for navigation to the Check, Share, Rewards and Settings processes and accompanying display pages.

By selecting the Reward icon 152 from the menu 150 (See highlighted button icon at bottom of FIG. 7A), the user will navigate to the “My Reward Challenges” screen. FIG. 7B shows an example of the “My Reward Challenges” screen which provides a variety of icons whereby the user may define a “Challenge”. In the case of the Gluco-Share embodiment, a Challenge defines when blood glucose information is to be input into the system by the user. To define the Challenge, the user would press a ““Press to Add” icon 154 in the “My Reward Challenges” screen (FIG. 7B). Twelve such icons are shown on See FIG. 7B because no Challenge has yet to be defined. When a challenge is defined, an icon depicting the type of challenge is shown instead of the Add icon.

An important feature of the Gluco-Share application is enabling the user to establish goals for checking and inputting data related to blood glucose level and to receive rewards for achieving those goals. In the case of Gluco-share, the system is focused on the time and frequency by which the user checks and records blood glucose level information. The system is not concerned with the actual blood glucose number although another embodiment of the invention may allow input, tracking, sharing and reward achievement based on blood glucose level information.

The Gluco-Share application defines a variety of time periods during which a user may wish to check and enter data relative to their blood glucose level. FIG. 7C shows a screen shot of various time periods defined by the Gluco-Share application including, but not limited to, the “Night Owl” time period from 12 a.m. to 3 a.m., the “Vampire” time period from 3 a.m. to 5 a.m., the “Rise and Shine” time period from 5 a.m. to 7 a.m., the “Breakfast” time period from 7 a.m. and 9 a.m., the “Brunch” time period from 9 a.m. and 11 a.m., and the “Lunch” time period from 11 a.m. to 2 p.m. The user may scroll to additional time periods not shown in FIG. 7C.

An example of a “Breakfast” challenge is seen on FIG. 7D which describes the challenge as the user checking blood glucose everyday between the times of 7 and 9 a.m. This can be set up as a personal challenge (in which case it is only viewed by the user) or the user can allow support persons (such as friends, parents and other users) to view the challenge. By pressing the plus icon 156 next to the challenge on FIG. 7C, the user is taken to a screen more clearly defining the challenge (See FIG. 7D). By pressing the “accept” button 158, the user accepts the defined challenge and at which point the user is tasked with checking and inputting data relative to completion of the task within the time period established by that challenge. When the user has accepted a challenge and returns to the “My Rewards Screen” (See FIG. 7E) the user will see an icon for the accepted challenge, for example the “Breakfast” challenge icon 160 seen in FIG. 7E.

The user may view statistics associated with his/her track record for complying with established and accepted challenges. FIG. 7F provides an example of the “My Stats” page providing statics associated with a user's compliance with a challenge requiring a check of blood glucose and input of data between 7 a.m. and 10 a.m. (i.e the Breakfast challenge). The system determines whether the inputted data meets the timing defined by the challenge. If, for example, the user forgot to check his or her blood glucose level between 7 a.m. and 10 a.m., the user interface would indicate that the user has failed that challenge for that particular day. If the user did check blood glucose levels and input that information into the system, the user interface will indicate that the user has met the challenge.

FIG. 7F is an example of the “My Stats” page pertaining to an accepted “Breakfast” challenge where the user has yet to establish any statistics relative to compliance with the challenge (in other words, the user has only accepted the challenge and has yet to check or input data). It shows the defined challenge (in this case, Breakfast) which requires that the user check his/her blood glucose between the defined time period (in this case 7 a.m. to 9 a.m.). It shows the statistics for compliance during the “Current Week” (Monday through Sunday) as well as the “History” which pertains to compliance over prior week periods. By pressing a “History” icon 162 pertaining to a particular week, the screen provides output of performance for each day of the selected week.

The level of compliance (or non-compliance) is indicated in a color coded fashion. If the use has complied with the challenge by checking blood glucose level and inputting data within the prescribed time period for a particular day, the application will show a green check mark for that day. If the user fails to comply by not checking or inputting data within the prescribed time period for a particular day, the application will show a red circle and cross hash for that particular day. If the user checks blood glucose within the time period, but does not input data until after the time period has passed, the application will show a yellow check mark for that particular day.

FIG. 7G is an example of the “My Stats” page showing a green check mark 164 under Monday of the current week indicating that the user checked blood glucose level and entered data within the Breakfast period on Monday of the current week. It also shows green check marks 164 on each day below a particular week defined under History. Those green check marks show that the user complied with challenge by checking blood glucose level and entering data during the prescribed time period each day of the particular week defined under History.

FIG. 7H is a screen shot showing a user's compliance on Monday of the current week but failure to comply on Monday and Thursday of a previous week (noted with red circles with cross-hash icon 166). The client partially complied on Tuesday and Friday of that week (noted with yellow check marks 168) and fully complied on Wednesday, Saturday and Sunday of that week (noted with green check marks 164).

A user may delete a particular challenge by pressing the Delete button 170 (shown on the upper right hand corner of the “My Stats” page relative to a particular challenge at which time delete challenge notice 172 will be displayed to the user telling the user he/she is about to delete a challenge and giving the option to continue or cancel (See FIG. 7I).

Each time a user complies with a particular challenge, the system issues rewards points to the user as well as to the defined user group. FIG. 7J provides an example of a display page showing of how points 174 are displayed relative to the user's performance in each challenge.

### Check Functionality and Interface

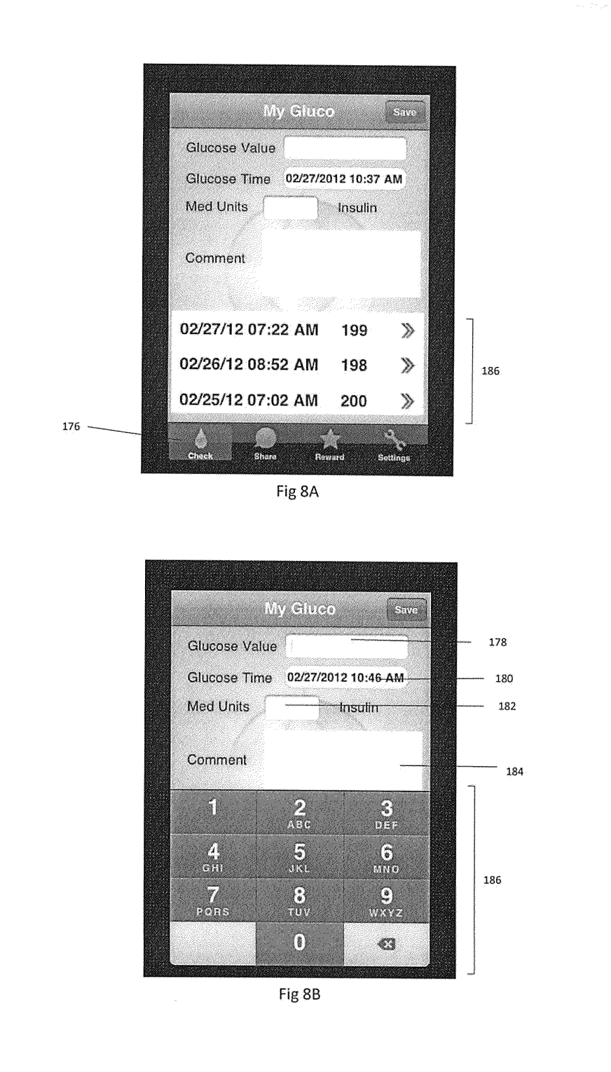

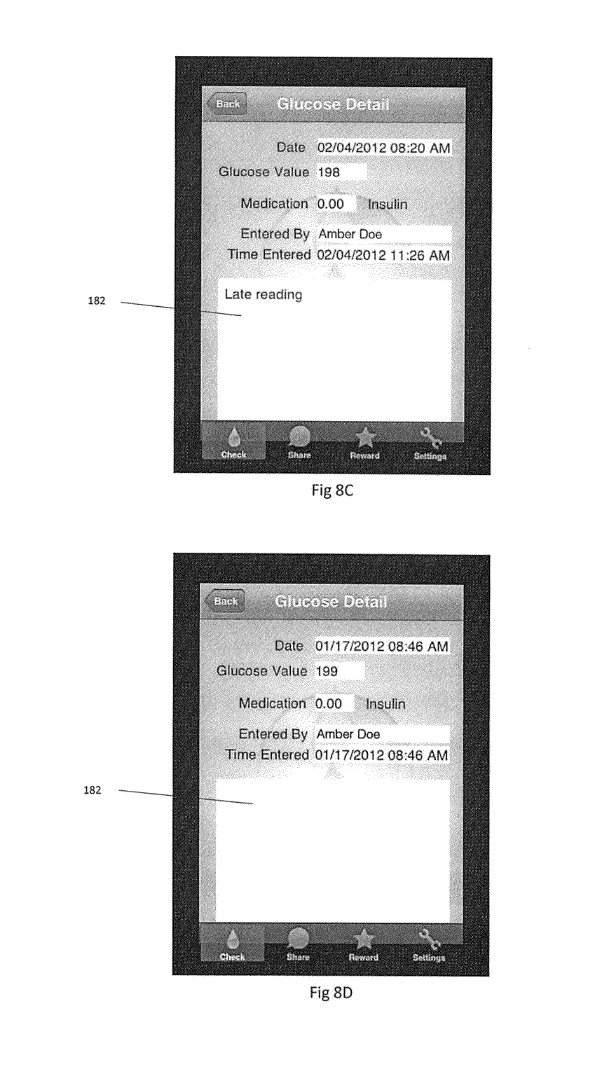

FIGS. 8(A through D) depict an embodiment of the user interface in greater detail. They are “display pages” showing the user interface of the Gluco-Share embodiment of present invention associated with the client-side application's Check functionality (i.e. the data input). The Check processes and associated interface provides for the entry of disease specific information related to defined challenges.

The user would enter information into the system to meet the pre-established challenges by entering blood glucose level information. The user does this using the menu button “Check” 176 to navigate to the data entry pages for entering specific disease management compliance information, such as blood glucose level data. In the Gluco-Share embodiment, these pages are labeled “My Gluco” as shown in FIG. 8A.

At the “My Gluco” screen, the user would enter information in the data entry fields including blood glucose value 178, the time in which the blood glucose level was checked 180, the units of insulin self-administered 182 and a comment 184 which is optional. FIG. 8B is an example of the “My Gluco” screen with input keyboard 186.

The Gluco-Share embodiment of the present invention as shown does not verify the blood glucose value. Instead the user is responsible for reading the blood glucose meter and physically entering the blood glucose level information into the application. In an alternative embodiment, the client-side application may be configured to read or otherwise obtain the blood glucose level information directly from the meter without the user having to manually load the information into the meter. In still another alternative embodiment, the application would be configured to verify the information which was either loaded manually by the user or which was obtained directly from the meter.

There are numerous alternative methods by which the application could be configured to obtain the blood glucose level information directly from the meter. For example, the application could be configured to read the digital output from the meter either through blue-tooth, infrared, direct connection line, or through a combination of camera and OCR (optical character recognition) all of which technologies are relatively standard in the industry and may be incorporated into the client-side application use the technologies currently available in most smart-phones or mobile devices. Optionally, the client-side application can be housed on a mobile device that is built into the meter itself. Or, again alternatively, the application may be loaded onto a reader or other mobile device technology that is coupled with another mobile device that enables other connection functionality. For example, the application could be housed on a meter reader that can be coupled with a smart phone which would provide the communication (phone, web, and text) connectivity to function with the system. The mobile application could be housed on a meter itself connectable to a smart-phone or other mobile device providing communication functionality as described in the system. There many possible variations.

There are numerous alternative methods by which the application could be configured to verify blood glucose levels that have already been automatically or manually entered into the system. For example, the client-side application could be configured such that the mobile device upon which it is stored may be connectable to one or more blood glucose meters which are being used by the user. It is not uncommon for diabetics to have a number of blood glucose meters available to them and stored in different places for convenience. The application would be configured to allow each of the meters to be read and the information obtained from those meters matched by the data base stored locally and at the server-side database or a remote database.

There are significant advantages to providing verification of input data. The primary purpose of the Gluco-Share embodiment of the present invention is to reward compliance with behavior goals—such as checking and sharing blood glucose level information at scheduled times. For the purpose of rewarding such compliance it may not be necessary to verify that the information about the actual blood glucose number is correct. But for other purposes, such as providing a doctor or other health care provider with information upon which they might alter treatment, it can be very helpful. And it is much easier for a user to be able to provide a single verified file of all blood glucose data on a single file to the doctor than to bring in the numerous blood glucose meters that the user might be using to check and record blood glucose data. While doctors and health care providers would be interested in the patient's hand input log of blood glucose readings, verified data would be even more beneficial for treatment purposes.

Referring back to FIGS. 8A and 8B, the comments section 182 provide a place for the user to record a note regarding anything associated with the blood glucose level data. For example, the user may not be entirely confident in the meter reading for whatever reason, the user may have input the value sometime later than when the meter reading was actually taken, the user may have used a friend's meter to read the test strip or the value input may have been just one or numerous readings that were taken at the time. Also, there may be certain contextual information which might be relevant to the level recorded. For example, the user may have just been exercising or could have eaten within close proximity to taking the reading. There is any number of comments that the user might not remember on his/her own and would want to record along with the blood glucose level. The comments field provides the user with the opportunity to record this information which might have some bearing on the accuracy or timing of the input data.

Also referring to FIG. 8A, the bottom of the screen provides a history of readings. The user may select any of the past readings 186 to review. These are readings that were previously entered into the system. In the case of the Gluco-Share embodiment, the user may not edit the past readings. However, the user may delete a previously recorded reading.

FIG. 8C shows a Glucose Detail display page wherein a notation is made in the comment field. In this example, the comment reads “Late reading” to mean that the reading was made after the specified time period for entering data as defined by a challenge.

FIG. 8D is a screen shot of a Glucose Detail page without a comment in the comment field.

### Share Functionality and Interface

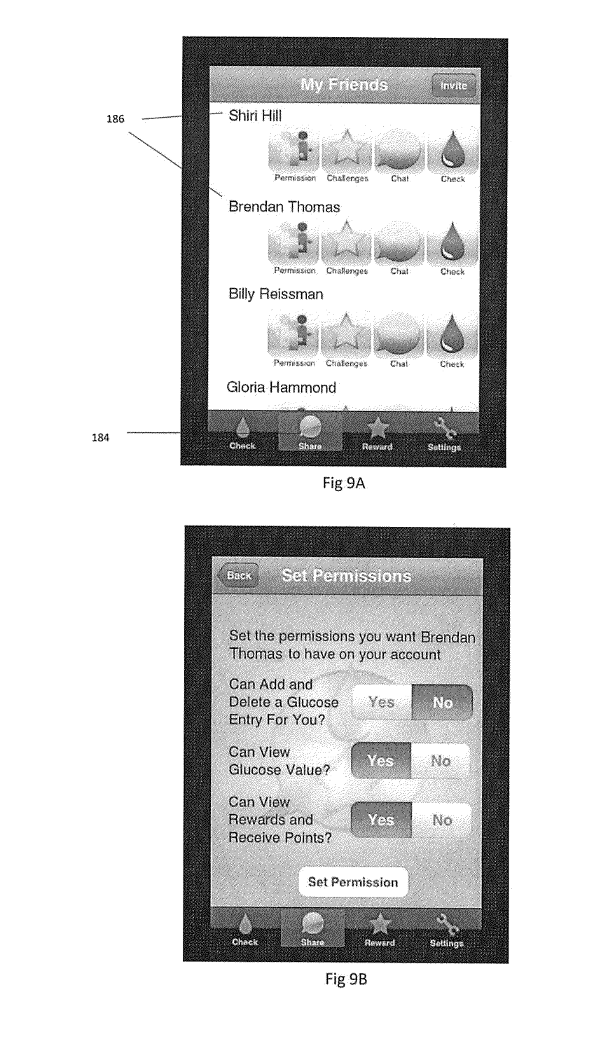

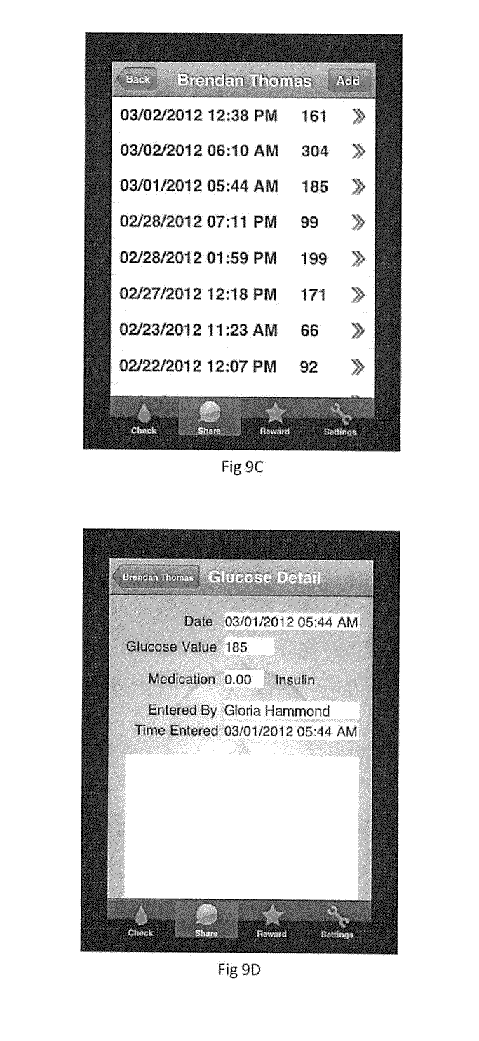

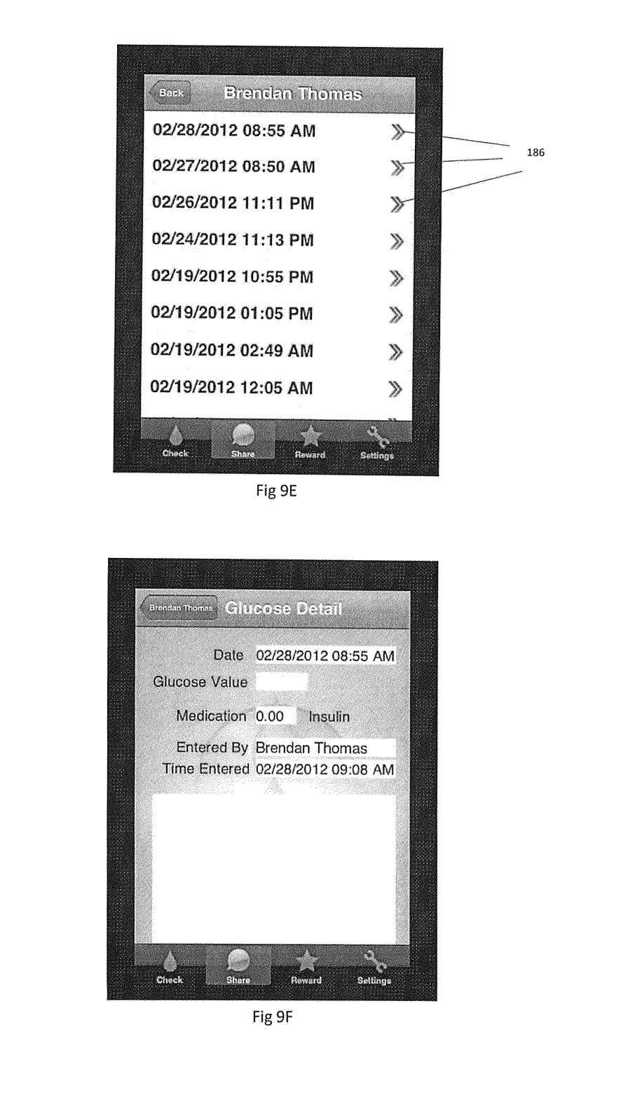

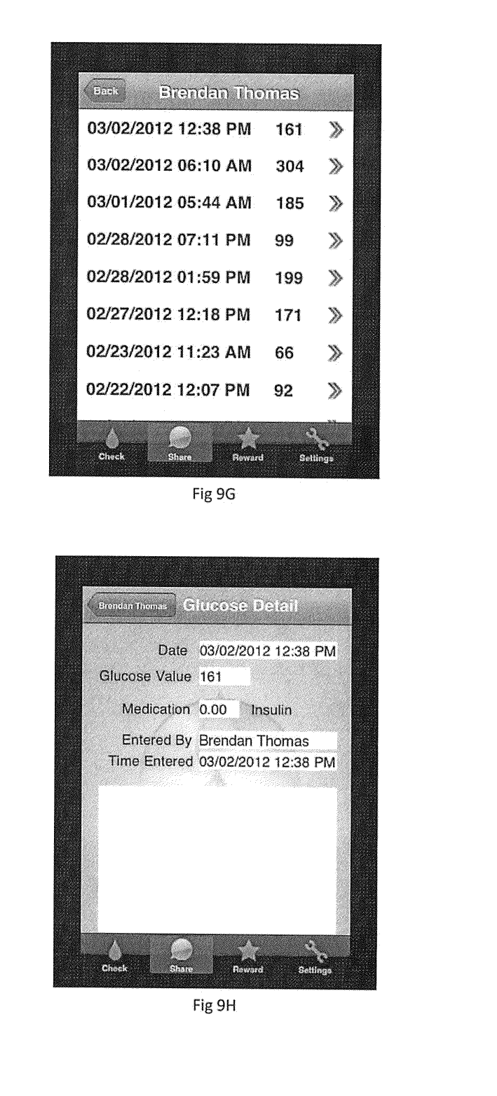

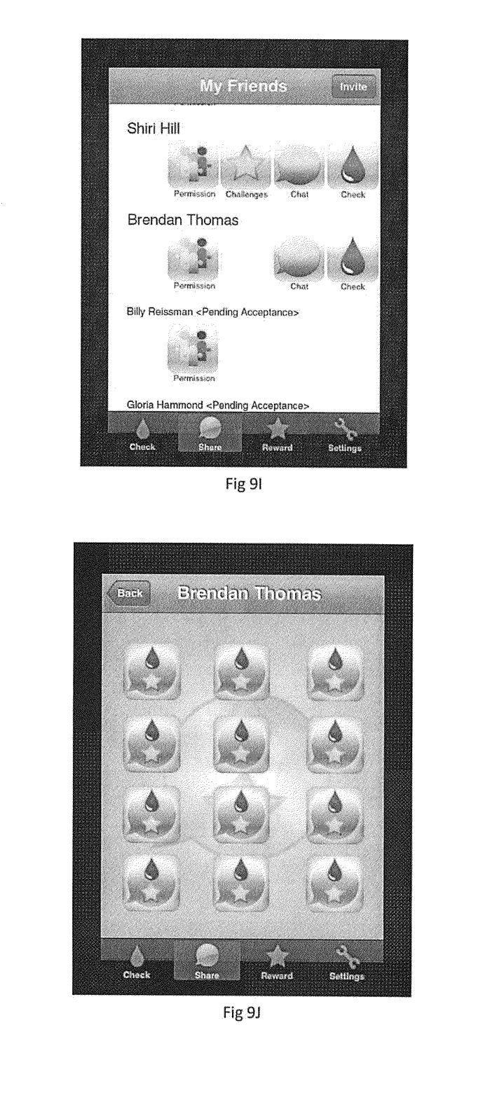

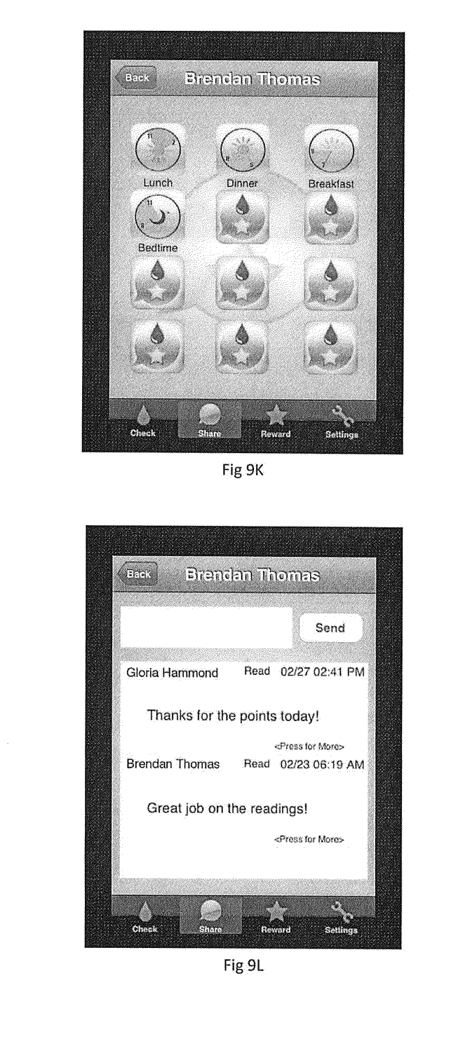

FIGS. 9(A through M) depict an embodiment of the user interface in greater detail. They are “display pages” showing the user interface of the Gluco-Share embodiment of the present invention associated with the client-side application's support network—or “Share”—functionality.

To establish connection to friends and other support persons through the inventive system, the system allows the user to invite and connect to other persons using communication functionality. In the case of the Gluco-Share embodiment, the user may navigate to a “My Friends” page (See FIG. 9A) by pressing the “Share” button 184 on the menu bar. The user will “invite” friends to join the user's network of support (i.e. those who the user might share data with) A friend can be a parent, spouse, child or some other support person that is registered as a Gluco-Share user. If they are not, the system will send an email to that person asking them to join. To join, they will download the client-side application.

FIG. 9A, which again is an embodiment of the “My Friends” page, provides the names of persons that the user has agreed to share information with regarding their compliance with their defined challenges. (See section pertaining to FIGS. 7 and 8 for further discussion of challenges functionality.)

A user who wants to share information with another registered (or potential registered) user will invite a “friend” into his/her network by providing the email address of the friend. The system will then send the friend an email, telling them that the user wants to add them as a “friend”. If the recipient is not already registered, the system will encourage them to join and guide them to download the application.

Once accepted as a friend, the system will list the name of the friend(s) 186 on the user's “My Friends” page. See FIG. 9A. Under each listed friend's name are four separate icons including “permissions”, “challenges”, “chat” and “check”

Functionality of “Permissions” Under Share Module

A user can then press the permissions icon below the friends name to define the criteria by which the friend will be provided access to the user's information. FIG. 9B is an example of the “Set Permissions” page where the user determines how information is to be shared with the “friend”. For example, the friend may be allowed to add or delete a glucose entry for the user. In other words, the user may allow a friend to input blood glucose data into the system and delete such information in the user's account. In the case of a parent who might occasionally be tasked with checking and inputting the blood glucose level of a child, that parent would be given permission to enter blood glucose information into the child's account and that data will be included in the child's database both locally and at the server. Similarly, the parent would be allowed to delete entered blood glucose value information from the user's account. The permission is set by the user using the “Set Permission” button

Once a permission is set by the user, the friend can see the data that the user has given the friend permission to see. Referring to FIG. 9B, for example, the user can give the friend permission to add and delete a blood glucose value for the user, view the blood glucose value, and receive rewards and points pertaining to the user's compliance with defined challenges.

FIG. 9C is an example of a share data screen for a particular friend of the user. In this screen the name of the friend is Brenden Thomas. The user has been granted permission to view the date and time when blood glucose information was entered into the friend's account as well as the blood glucose value.

If the user wants additional information about the data and information input into the friend's account, the user would press the arrow icon next to the particular value and the system will navigate to a “Glucose Detail” screen (See FIG. 9D) where the user can view the input information in more detail. That additional detail could include information about who entered the data (the friend or someone else) and the time when the information was entered into the system.

FIG. 9E is a display page of a share data screen for a particular friend of the user. It is similar to that shown in FIG. 9C except in this case the friend has not given the user permission to see the blood glucose values entered into the friend's account and therefore there is no information shown in the glucose value field. The friend has only give the user permission to view the date and time when a blood glucose value was checked and entered into the system. Should the user press an arrow button 186 to view additional detail, the user will be taken to the “Glucose Detail” page FIG. 9F which is similar to that shown in FIG. 9D except that the Glucose Value is omitted. FIG. 9F is an example of a display page for a friend that has not given permission to view their glucose readings whereas FIG. 9H is a glucose detail display page for a friend that has given permission to view their glucose readings.

Functionality of “Challenges” Under the Share Module

The user may allow one or more friends to see the challenges (i.e. compliance goals) which have been established by the user. The user may also allow friends to see the user's progress.

Each of the permissions are independent of one another and may be revoked by the user at any time. Further a parent of a child user under 13 may see, revoke and edit any challenge of the child user. After adding, deleting of editing any permission, the user would press “Set Permission” to enter the permission into the system.

Looking at FIG. 9I, when a user has provided a friend with access to his/her challenges, the friend will be able to see the selected user challenges use the Friends page. Under the name of the friend providing such permission, a “challenges” icon will appear. For example, FIG. 9I shows that the friend Shiri Hill has given the user permission to see her “challenges” and therefore the challenges icon is shown under her name. The friend Brenden Thomas has not given the user permission to see his challenges and thus no “challenges” icon appears under his name.

If the user does not have permission to see the friend's challenges, the user will need to ask the friend for permission to see them. That is something that only the friend can control. But if the friend has permission to see the user's challenges, the friend will be shown the “My Stats” page listing the progress of the user in meeting his/her challenges.

FIG. 9J depicts a screen shot showing that the friend Brenden Thomas has no challenges set up with the user.

FIG. 9K depicts a screen shot showing that the friend Brenden Thomas has set up several challenges (Lunch, Dinner, Breakfast and Bedtime) which the user has been given permission to view.

Functionality of “Chat” Under the Share Module

If the user wants to share a message with a friend, the user would press the Chat icon under the name of the friend listed on the My Friend's page. The user will then be shown a chat screen (See FIG. 9L) with the name of the friend listed at the top and a box for entering a message. The user may have already checked the friends performance under the Challenges section and may want to send a note of encouragement and receive a response. In that case the user would enter the note and press send. If and when the user receives a message or return message from the friend, the user will see a new message number appear on the Share button at the menu bar. The numbers next to the Share icon at the menu bar will vary depending on how many messages are waiting for the user to review.

Functionality of “Check” Under Friend's Module

If the friend gave the user permission to see their blood glucose numbers through the permission function of the Share module, the user may navigate to that data by pressing the “Check” icon underneath the friend's name and pressing the specific entry to be reviewed. If the friend gave the user permission to view the dates and times when they entered a blood glucose value but not the values themselves, the user will see a list of dates and times when the friend entered a value in the system.

### Notifications Functionality and Interface

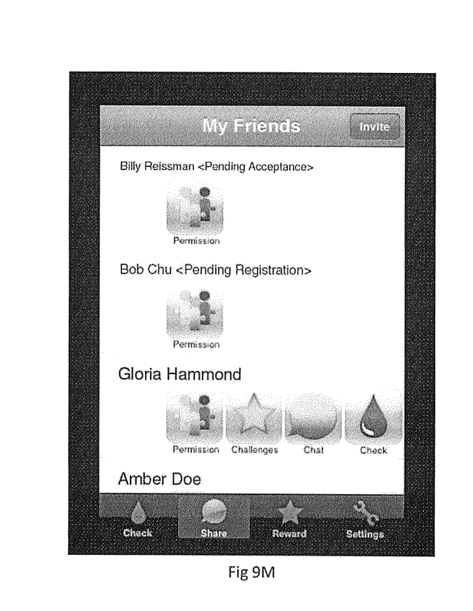

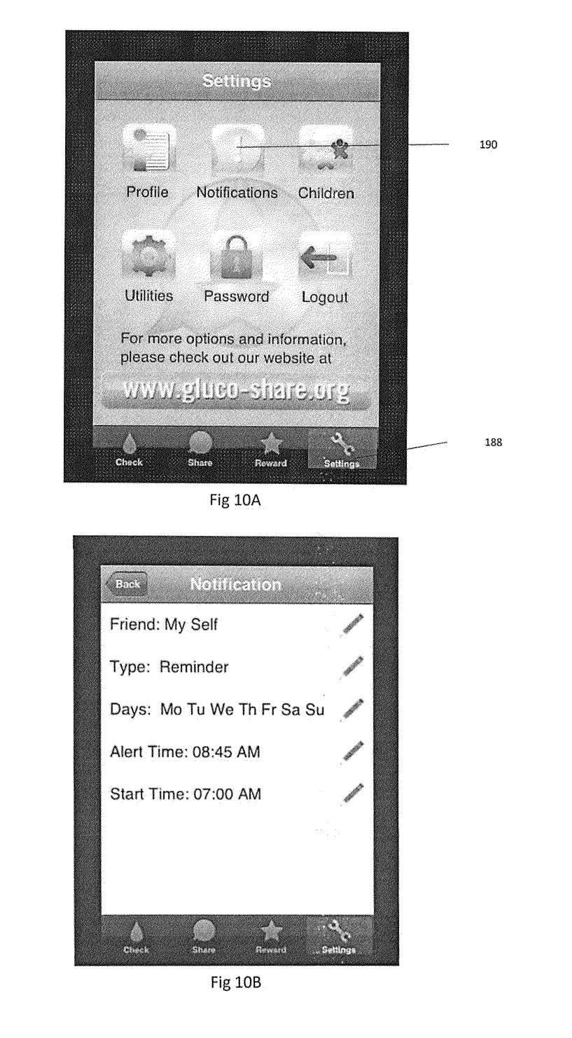

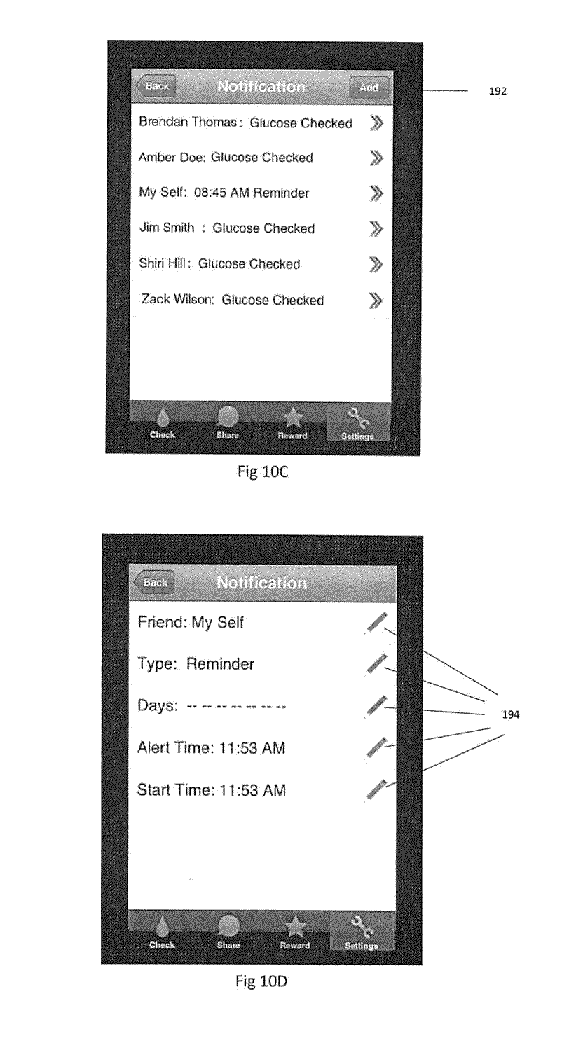

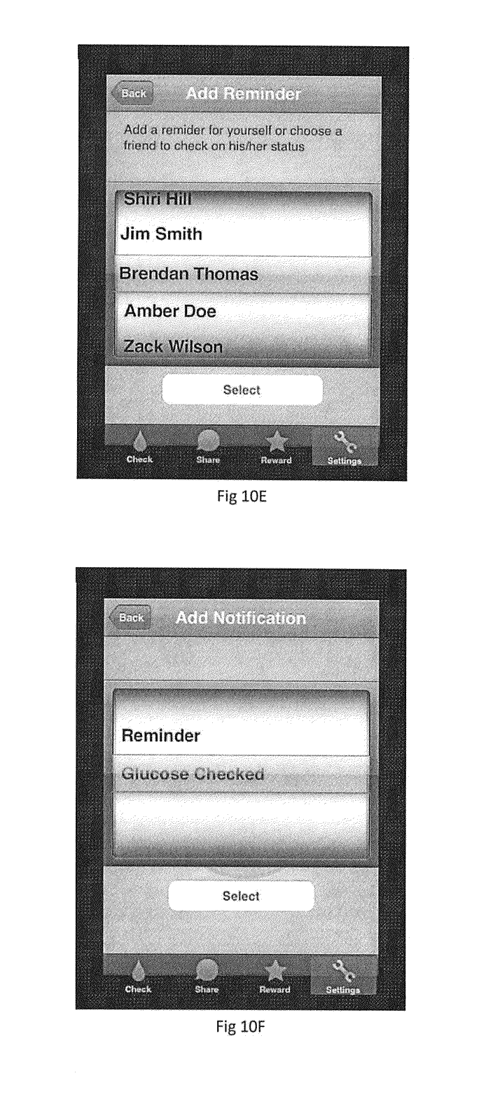

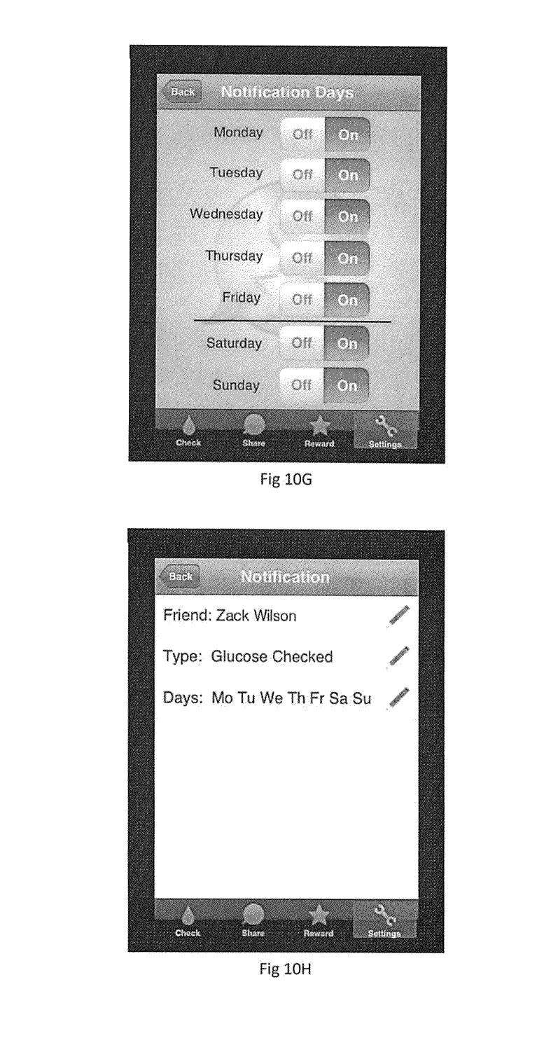

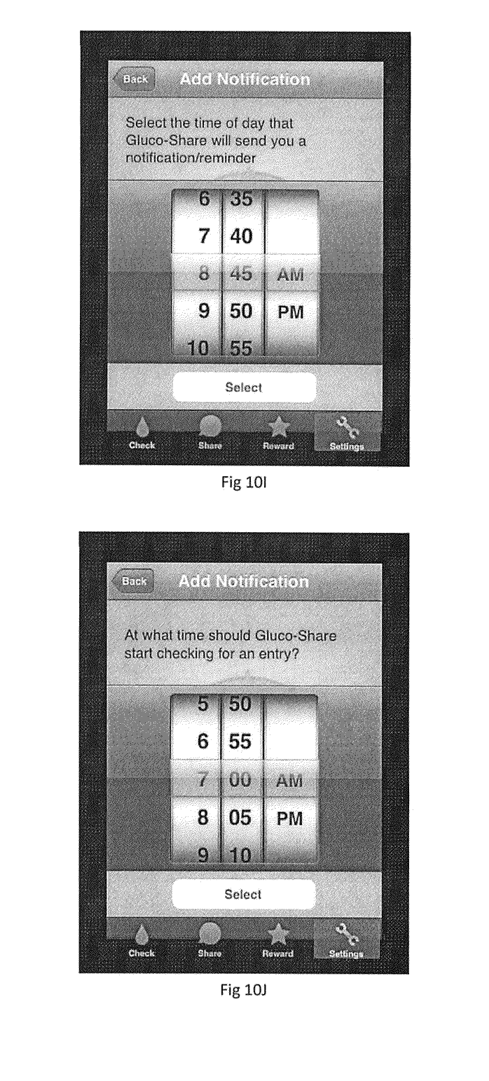

FIGS. 10(A through J) depict an embodiment of the user interface in greater detail. They are “display pages” showing the user interface of the Gluco-Share embodiment of the present invention associated with the client-side application's Notifications functionality.

The Notifications functionality allows the user to set up reminders pertaining to the user's own performance or to the performance of a friend. The user may set up a reminder for a certain date and time and then allow a window of time before a notification is sent. If the user or the friend has not checked a blood glucose level and entered values in the system within that time window, the user will receive a notification (i.e. a message display page) on his/her mobile device notifying the user and allowing the user to take action.

So, for example, if a user wants a reminder regarding his/her own performance, the user will set up the system to receive a notification at a certain date and time along with a window of time in which the system is to check to determine whether any value has been entered. If the user wants to receive a reminder at 3:30 if he/she fails to enter a value between 3:00 p.m. and 3:30 p.m., the user would input a date, the time of 3:30 p.m. to receive the reminder and a allowance window from 3:00 p.m to 3:30 p.m. In that case, the system would automatically send the user with a reminder at 3:30 telling the user whether any data was entered by the user between 3:00 and 3:30. If the user wants to receive notification only if he/she fails to enter data, that Type of reminder can be chosen under the Type entry.

If a user wants to be automatically notified about a friend's performance (for example, whether that friend has check his/her blood glucose level and entered a value within a certain window), the user would specify the friend's name, the type of reminder, the date or days in which the user wants to receive the reminder (the user may want to receive reminders on Mon, Tues, and Wed. only for example), the time of day when the reminder is to be sent and the allowance window to be checked by the system.

The allowance time may be provided in days, hours and minutes. This allowance time is the window of time defined by the user which will pass before the user is to be prompted about whether or not the friend has complied with the chosen type of notification. For example, if the user knows the friend is having trouble remembering to do a test at 3:30 p.m., the user would set a notification about that friend for 3:30 p.m. and allow a window of time (15 minutes for example) to check on the friend's activity. If the friend has not entered a value by 3:30 p.m., the user will receive a notification at 3:30 indicating that the friend has entered no data in the system within the last 15 minutes.

The notifications functionality is helpful in that a user may determine when from a set time the user wants to receive an update on a friend's performance so the user may communicate (through Chat or other means) with the friend to see what is going on.

To set up a notification, the user would press the Settings icon 188 from the menu bar. At the Settings page (see FIG. 10A) the user would select the Notifications icon 190 at which time they would be provided a Notifications page listing all previously defined notifications and providing the option to add a notification. FIG. 10C is an example of a Notifications page. If the user wants to add a new notification, the user would press the “Add” button 192 at the top of the Notifications page (See FIG. 10C). To view a particular set notification, the user would press the arrow to the right of that set notification. FIG. 10D is an example of the detail associated with a particular notification that has already been defined by the user. That detail lists the friend (which can be the user “My Self”), the type of reminder, the day, the alert time (that is the time when the notification is to be sent by the system), and the start time which defines the beginning of the window for entry of data. Each of these defined data points can be edited by selecting the edit icon to the right of the data value.

The user may add a new notification by selecting the “Add” button at the Notifications page (See top right of FIG. 10C), and from here the user may navigate to the various screens which allow data input for friend, type, days, alert time and start time. The user would press the stylus icon 194 next to each field to navigate to display page where the user may make the desired entry (See FIG. 10D).

FIG. 10E is an example of a data entry display page where the user may select the name of a registered friend in his/her account.

FIG. 10F is an example of a data entry screen where the user may select the type of notification requested. By selecting “Reminder” option, the user will be notified within a time allowance window if the subject of the reminder (again, the user or a friend) has not made a blood glucose level entry in the system by the time of day selected. If an entry is made within the selected time window, no reminder will be sent. The “Glucose Checked” option only applies when a user's friend is the subject of the reminder. If the user selects this option, the user will get a notification when a friend enters information under the “Check” module on their application within the defined time allowance window. This gives the user the opportunity to check the stats and/or challenge performance of the friend and send them a note of encouragement via Chat if so desired.

FIG. 10G is an example of a data entry display page where the user may select which days of the week in which the user wants the system to perform the check and notification. This screen provides a list of the days of the week with an Off and On button to the right of each listed day. By choosing On, the user is telling the system to check on that particular day of the week. This function allows the user to determine which day or days of the week, he/she wants to receive a reminder.

FIG. 10H is an example of a notification detail display page. In this example, the friend is identified as Zack Wilson—this means that the user will receive the reminder relative to Zack Wilson's data entry. The type of reminder to be received by the user about Zack Wilson is “Glucose Checked”—this means that the user want to be sent a notification if Zack Wilson checks his blood glucose level. The days of the week that the user wants to be notified are all the days of the week which his this example is Monday through Sunday.

FIG. 10I is an example of a data entry display page where the user may select the time of day that notification will be send to the user. If the notification is about a friend's performance it is considered a notification. If the notification is about the user's performance, it is consider a reminder.

FIG. 10J is an example of a data entry display page where the user may select the start time for the system to check for a data entry. If for example, the user sets the time as 7:00 a.m. (as in FIG. 10J) and the notification time as 8:45 a.m. (as in FIG. 10I), this defines the window of time that the user is interested in knowing whether the friend has entered data.

Assuming, for example, the user wants to make sure that a friend is entering a value within particular time frame. The user will define the time frame using the start time and the notification/reminder time. If the user has set him/her-self to be the subject of the reminder, the user will receive a reminder notification if the user does not enter a value in the system within that time frame. If the user has set up the notification to check whether a friend has entered data within the window, he will receive a notification telling him/her whether or not the user has entered a value during the defined window of time.

### Permissions and Parental Controls Functionality

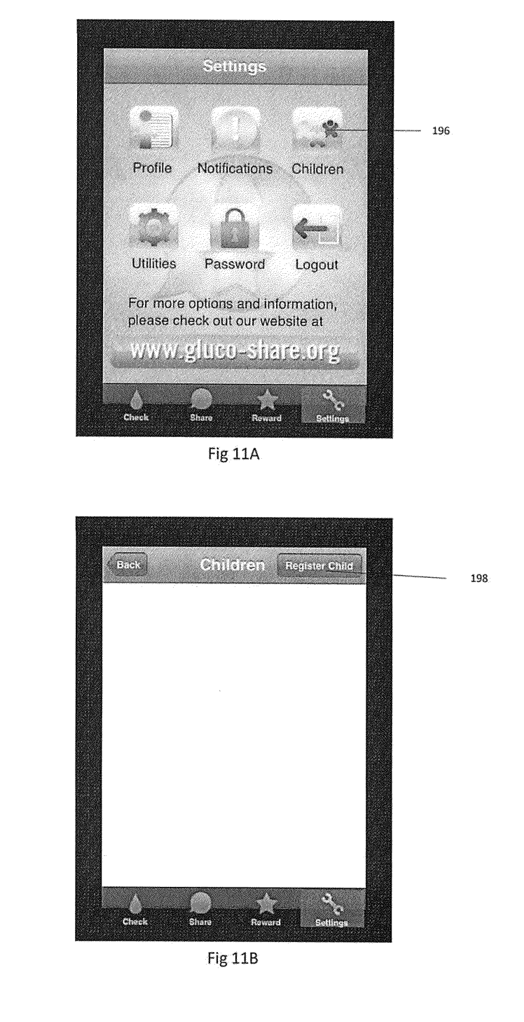

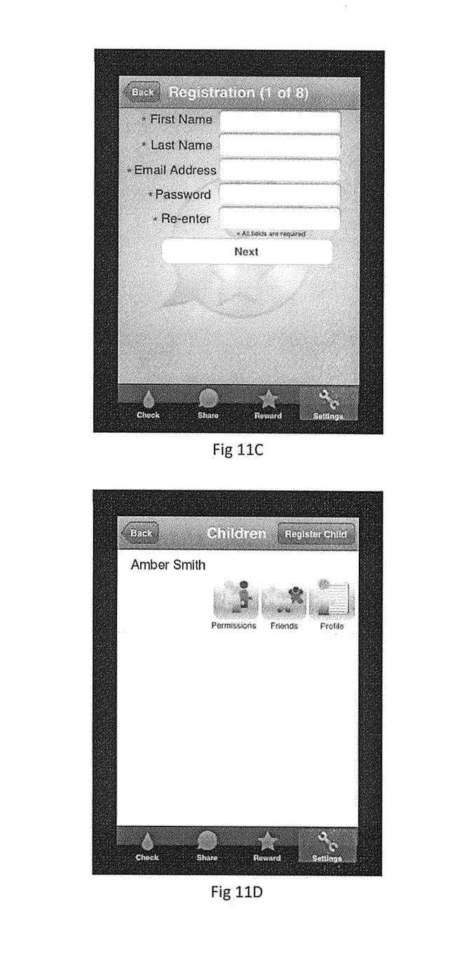

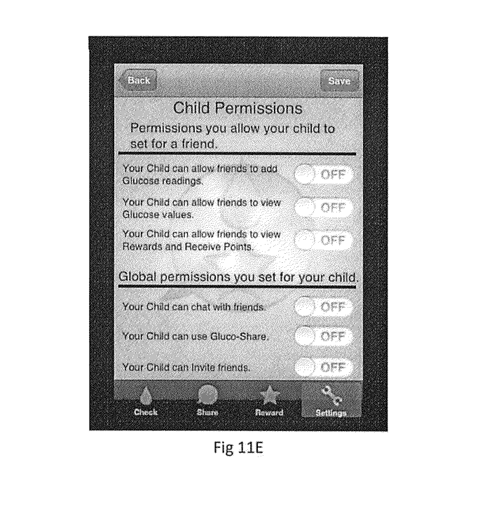

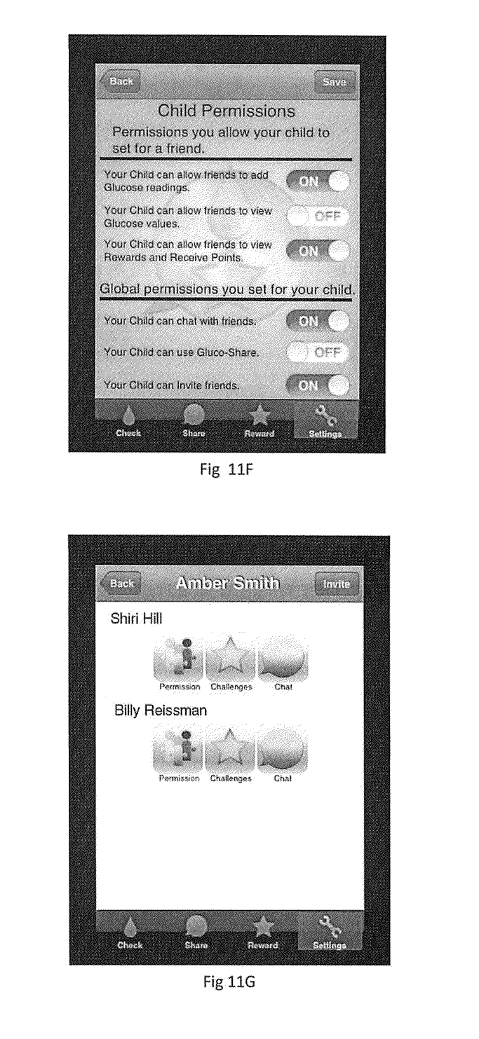

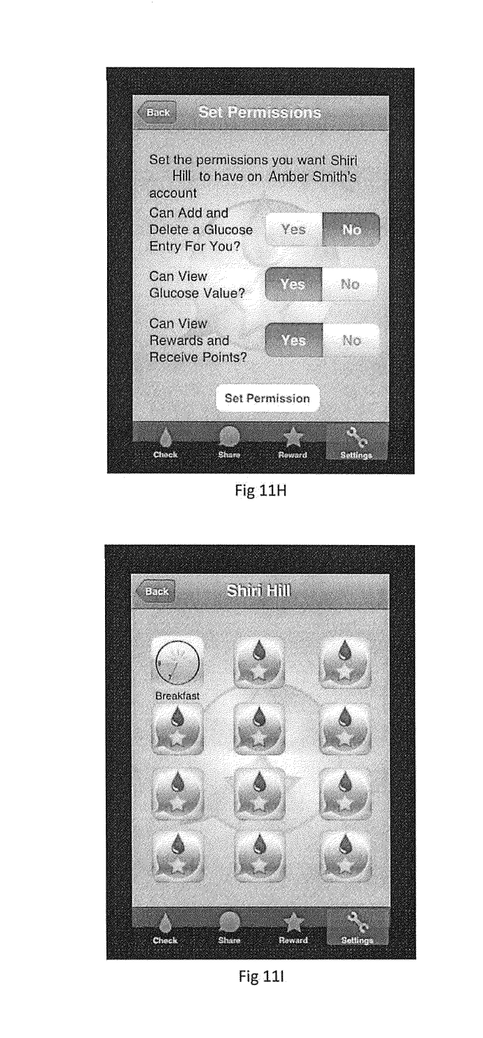

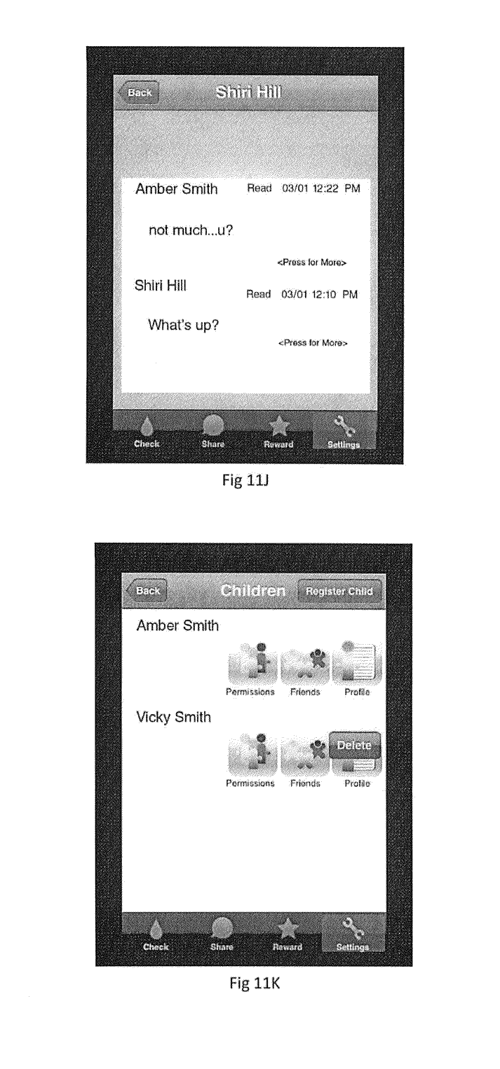

FIGS. 11(A through K) depict an embodiment of the user interface in greater detail. They are ‘display pages” showing the user interface of the Gluco-Share embodiment of the present invention associated with the client-side application's Permissions and Parental Control functionality.

FIG. 11A is a screen shot of the Settings page which may be reached by the user by pressing the “Settings” icon at the menu bar. Listed on the Settings page are various functionality icons including Profile, Notifications, Children, Utilities, Password, and Logout.

Should the user press the Children icon 196, he/she will navigate to the Children page (FIG. 11B) which lists the registered children of the parent user. In this example, no Children have yet been registered by the user.

By pressing the Register Child button 198 (See top of FIG. 11B), the user will be taken to the first of eight registration pages (FIG. 11C). The eight step registration process for registering a child user has been described in FIGS. 5B through FIG. 5L and associated description above.

Once a child has been registered, the name of the child will be shown in the Children page with icons providing options for the parent user to change the selected child's Permissions, Friends, and Profile (See FIG. 11D). By pressing these icons, the parent user may control the functionality of the child user's application/account.

Changing a Child User's Permissions

By pressing the Permissions icon under the Child's name in the Children page (FIG. 11B), the parent user may navigate to the “Child Permissions” page (See FIG. 11E) where the parent may change the child user's permissions. FIG. 11F is an example of the Child Permissions page with preferences selected. The parent may control permissions that the child may set for a friend (such as allowing friends to add Glucose readings, allowing friends to view inputted Glucose values, and allow friends to view Rewards and Receive Points for performance on Challenges. The parent may also set more global permissions for the child (such as giving the child permission to use Gluco-Share at all, permission to Chat with friends, or permission to invite friends). These permissions cannot be altered by the child user. They can only be altered by the registered parent.

Viewing a Child User's Sharing Functionality

By pressing the Friends icon under the Child's name in the Children page, the parent user may navigate to a list of the child user's registered friends (see FIG. 11G) In this example, the name of the child is Amber Smith, and Amber has two registered friends Shiri Hill and Bill Reissman. Under each of the friend's names are Permissions, Challenges and Chat icons. The parent may view the child user's (in this case Amber's) permissions, challenges and chat associated with the designated friend.

FIG. 11H shows an example of the set permissions display page pertaining to one of the child user's registered friends. Here, the parent may control the permissions between the child and the friend (for example whether the friend can add or delete a blood glucose entry for the child user, whether the friend can view the glucose value for the child, and whether the friend can view Rewards and Receive Points for the child's performance).

FIG. 11I shows an example of the challenges display page pertaining to one of the child user's registered friends (in this case Shiri Hill). By pressing the challenges icon under Shiri Hill's name (See FIG. 11G) the parent user navigates to the page (again FIG. 11I) showing the challenges that the child user has set up with Shiri Hill (in this case a Breakfast challenge).

FIG. 11J shows a screen shot example of the chat activity pertaining to one of the child user's registered friends (again Shiri Hill). This page is the log showing chat communication history between the child user and Shiri Hill. If the parent is unhappy with the chat that is going on between the child and the friend, the parent may change the permissions pertaining to the child user's account and deny access to chat with that particular friend or all friends if the parent chooses.

FIG. 11K shows a screen shot example of a Children page showing two registered children. If the parent does not want a child's profile to be accessible to a child's friend, the parent may delete the child's profile. In this example, the profile button under Vicky Smith's name has been deleted by the parent.

### Utilities Functionality

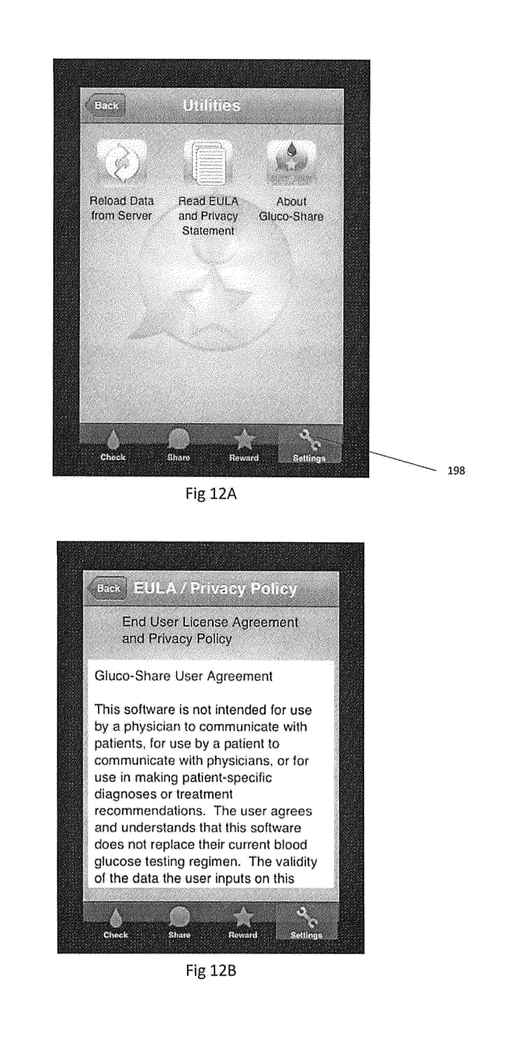

FIGS. 12(A through C) depict an embodiment of the user interface in greater detail. They are “display pages” showing the user interface of the Gluco-Share embodiment of the present invention associated with the client-side application's Utilities functionality.

FIG. 12A shows the Utilities page which is accessible through the Settings page which is accessible through the Settings button on the menu bar. By pressing Through the Settings page, the user may reload data from the server, access information about the application and other posted information such as the user agreement (FIG. 12 B).

### Specific Methods and Routines Aiding Functionality

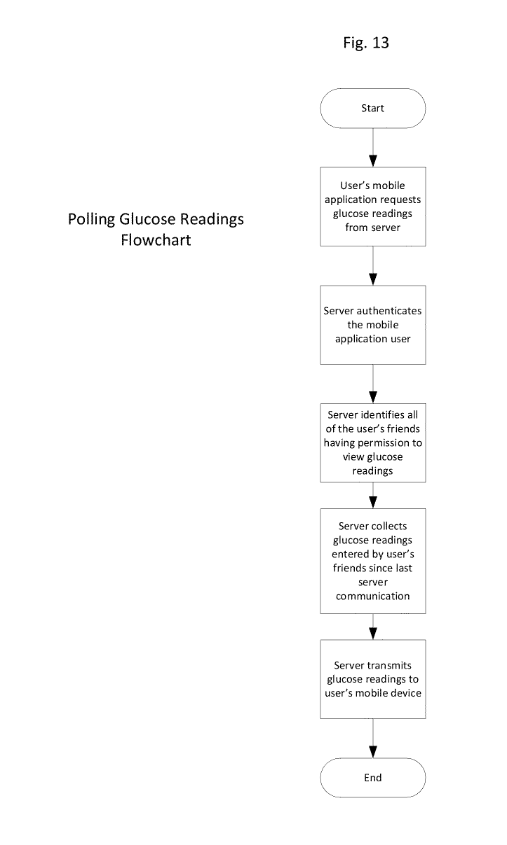

FIGS. 13 through 15 are flow charts depicting specific methods which aid the functionality of the present invention.

FIG. 13 is a flowchart showing an embodiment of the method for polling, that is synchronizing the information in the client side application with the information in the server-side application. The polling process as it relates to the current inventions is different from the prior art in that it involves the step of determining permissions before allowing information to be transferred. As shown in FIG. 13, the polling method involves the steps of 1) the user's mobile application requesting information (in the case of Gluco-Share, the information is glucose readings); 2) the server authenticates the mobile application server; 3) the server identifies all the user's friends having permission to view the information; 4) the server collects the information entered by the user's friends since the last server communication; and 5) the server transmits the information to the user's mobile device.

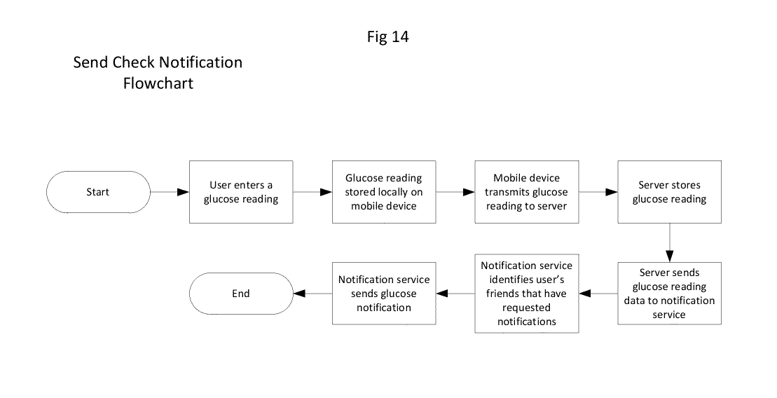

FIG. 14 is a flowchart showing an embodiment of a method for sending check notifications which are receiving user controlled notifications. The friend of the user controls how and if this notification is sent. If the receiving friend has not been given permission by the user to view the actual glucose value, the notification provided to the friend will only say that the user has tested (i.e. complied with the regimen task) and will not give the associated value (for example, the blood glucose value entered by the user). As shown in FIG. 14, the check notifications method consists of the following steps: 1) the user entering data (in the case of Gluco-Share, a blood glucose value or “reading”; 2) the data is stored locally on the mobile device; 3) the mobile application transmits the information via the mobile device to the server through a network; 4) the server stores the information; 5) the server sends the information to a notification server; 6) the notification server identifies the user's friends that have requested notifications; 7) the notification server sends the information to the user's friends.

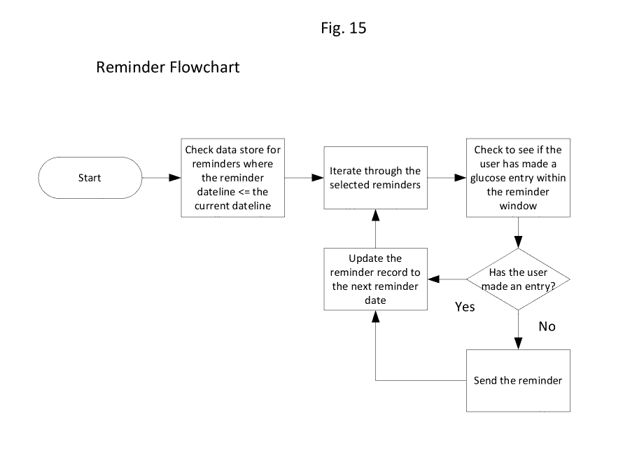

FIG. 15 is a flowchart showing an embodiment of a method for sending reminder notifications. Like the method shown in FIG. 14, this method for sending reminder notifications is controlled by the receiving user (or friend). This is a smart reminder that allows the user to set a time frame (i.e. window) for compliance with the regimen task. If the user has not tested in the specified time frame, a notification will be sent to the friend. In this way, the notification is only sent if needed. As shown in FIG. 15, the method for sending reminders consists of the following steps: 1) the server checks the database for reminders 2) the server iterates through the selected reminders; 3) the server checks to see if the user has made a data entry within the specified time frame (i.e. window); 4) if the user has made a data entry within the time frame, the server updates the reminder record to the next reminder date and no reminder is sent; If the user has not made a data entry within the time frame, the server sends the reminder to the designated recipient. While the configuration of the notification occurs at the client application (mobile or web), the server sends the notification to the recipient's mobile device (for example through SMS or Email).

Unless defined otherwise, all technical and scientific terms used herein have the same meaning as commonly understood by one of ordinary skill in the art to which the present invention belongs. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirement without departing from those principles. The appended claims are intended to cover and embrace any and all such modifications, with the limits only of the true purview, spirit and scope of the invention.

I claim:

1. A user interface for rewarding compliance with a blood glucose level monitoring regimen, comprising:
a mobile application for storing, verifying, sharing and rewarding a user's compliance with said regimen,
wherein the mobile application allows users to customize permission rules for sharing data and rewarding monitoring compliance.

2. The user interface of claim 1, wherein the mobile application is stored in memory on a mobile device.

3. The user interface of claim 2, wherein the mobile device is at least one of the following; a cellular phone, a smart-phone, a laptop computer, or a personal digital assistant.

4. The user interface of claim 1, wherein the mobile application includes one or more display pages for setting up challenges which may require a user to enter blood glucose level monitoring data within a defined time frame.

5. The user interface of claim 1, wherein the mobile application includes one or more display pages for entering blood glucose level monitoring data within a defined time frame.

6. The user interface of claim 1, wherein the mobile application includes one or more display pages for defining other users with whom blood glucose level monitoring data will be shared.

7. The user interface of claim 1, wherein the mobile application includes one or more display pages for defining permissions for sharing blood glucose level monitoring data with other users.

8. The user interface of claim 1, wherein the mobile application includes one or more display pages for viewing information about the user's compliance with the blood glucose level monitoring regimen.

9. The user interface of claim 1, wherein the mobile application includes one or more display pages for setting up notifications.

10. The user interface of claim 1, wherein the mobile application accesses a central server and database.

11. A system for encouraging compliance with a blood glucose level monitoring regimen comprising:
a mobile device having a memory, wherein the memory includes a mobile application for storing, verifying, and sharing data pertaining to a user's compliance with said monitoring regimen,
wherein the system provides for customized sharing of data, and
wherein the system provides for rewarding monitoring compliance.

12. The system of claim 11, wherein the mobile device is selected from the following:
a cellular phone, a smartphone, a laptop computer, or personal digital assistant.

13. The system of claim 11 further comprising a central server having a memory with additional software for communicating with said mobile device.

14. The system of claim 11, wherein notifications are provided to other users based on a user's compliance with a blood glucose level monitoring regimen.

15. The system of claim 11, wherein rewards are provided to one or more users based on a user's compliance with a blood glucose monitoring regimen.

16. A method for encouraging compliance with a blood glucose level monitoring regimen comprising:
displaying, on a video display of a mobile device, a mobile application for storing, verifying, and sharing data pertaining to a user's compliance with a blood glucose level monitoring regimen, and
rewarding compliance with a blood glucose level monitoring regimen.

17. The method of claim 16, wherein the sharing of data comprises the steps of:
establishing users with which to share information,
setting permissions which define the type of information to be shared,
creating personal challenges,
entering blood glucose level data in accordance with said personal challenges, and
providing notifications to other users about a user's compliance with the challenges.

18. The method of claim 17, further comprising the step of:
registering children users in compliance with the Children's Online Privacy and Protection Act (COPPA).

19. The method of claim 17, further comprising the step of:
sending messages to friends via email, phone, chat or text.

20. The method of claim 16, wherein the rewarding of a user's compliance comprises the steps of:
defining one or more challenges,
entering blood glucose level information in accordance with said one or more challenges,
providing rewards based on one or more user's performance in completing said one or more challenges.
